(19) United States
(12) Patent Application Publication
(10) Pub. No.: US 2026/0301580 A1
(43) Pub. Date: Oct. 1, 2026

(54) SYSTEMS AND METHODS FOR AIRSPACE AND AIRPORT USAGE MANAGEMENT

(71) Applicant: Plan de Vol International Inc., Oshawa (CA)

(72) Inventors: Jin Woo Hang, North York (CA); Jonathan Perry, Whitby (CA); Simon Bermudez, Toronto (CA); Paul Majewski, Courtice (CA); Emin John, Mississauga (CA); Bernard Gonsalves, Oshawa (CA)

(21) Appl. No.: 19/635,527

(22) Filed: Mar. 31, 2026

Related U.S. Application Data
(60) Provisional application No. 63/781,263, filed on Mar. 31, 2025.

(51) Int. Cl. G08G 5/20; G06Q 30/0283; G06Q 50/40

(52) U.S. Cl. CPC G08G 5/20; G06Q 30/0284; G06Q 50/40

(57) ABSTRACT

Provided are methods, systems, and devices for airspace and airport management. In one example, geospatial data related to airspace boundaries, with geographical point-based data including Flight Information Regions (FIRs), Upper Information Regions (UIRs), latitude, longitude, and sequence numbers are used along with geospatial polygons based on the geospatial data to define airspace boundaries. Route strings representing waypoints that define a planned flight path are processed by decoding them into geographic coordinates, which include latitude and longitude values. A flight path is constructed based on these coordinates, and flown coordinates are determined from real-time flight data to construct flown data. Either the flight path data or the flown data is assigned as selected route data based on a country-specific billing function. Intersection coordinates are determined based on the intersections between the geospatial polygons and the selected route data, and distance and time values are computed based on these intersections for determining actual plane flight paths flown.

### CROSS-REFERENCE TO RELATED APPLICATION

This application claims the benefit of U.S. Provisional Patent Application No. 63/781,263, filed Mar. 31, 2025, the entire contents of which are incorporated herein by reference.

### FIELD

The embodiments described herein generally relate to systems and methods for monitoring and determining airspace and airport service usage, and in particular, to the collection and analysis of flight path data, airspace boundaries, and real-time flight information for determining overflight and terminal usage under country-specific regulations.

### BACKGROUND

The following is not an admission that anything discussed below is part of the prior art or part of the common general knowledge of a person skilled in the art.

Airports and Air Navigation Service Providers (ANSPs) play a major role in managing the variety of services required for efficient flight operations. The services include aircraft traffic control (ATC), navigation, and ground services such as baggage handling to passenger processing. Each service requires the precise collection and processing of operational data. However, current systems used by Airlines and ANSPs often face inefficiencies in managing and processing the high volumes of complex, multi-source data that flight operations generate on a daily basis. This limits the ability of Airlines and ANSPs to accurately determine and manage airspace and airport usage for various items such as calculate costs, leading to operational delays and revenue leakage.

Accordingly, there is a need for alternative systems and methods that can address the inefficiencies of the conventional systems.

### SUMMARY

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

In one aspect, in accordance with the teachings herein there is provided a server for determining airspace and airport service usage including costs for a plurality of users for a plurality of airplane flights, the server comprising: a communication interface for communicating with external systems for receiving airspace and airport service usage; a memory that stores program instructions for determining airspace and airport service usage and costs; and a processor that is operatively coupled to the communication interface and the memory, the processor, when executing the program instructions, being configured to: access the external systems to receive, for a given airplane flight, a route string and flown navigation data; generate plan route data by decoding the route string, wherein the plan route data includes plan route geographic coordinates generated by translating encoded waypoint data; generate a plan route line providing a plan route geographic representation of latitude and longitude values based on the plan route geographical coordinates; generate flown route data by extracting sequential waypoint data from a flown navigation data, wherein the flown route data includes flown route geographic coordinates; generate a flown route line providing a flown route geographic representation of the flown route geographic coordinates; determine a plan route intersection object and a flown route intersection object, wherein the plan route intersection object includes a plurality of plan route intersection coordinates at the points where a plurality of FIR boundaries intersect with the plan route line, and wherein the flown route intersection object includes a plurality of flown route intersection coordinates at the points where the plurality of FIR boundaries intersect with the flown route line; and update a flight database to include flight reference data, aircraft type data, FIR code, distance covered in a corresponding FIR, and time elapsed in the corresponding FIR.

In at least one embodiment, the processor is further configured to: select a country billing function based on the plurality of FIR boundaries intersected by either a plan route intersection object or flown route intersection object; and determine a charge value data by applying a selected country billing function on data values in an associated intersection object, wherein the selected country billing function is associated to either the plan route intersection object or the flown route intersection object, and wherein the data values include flight reference data, aircraft type data, FIR code, distance covered in a corresponding FIR, and time elapsed in the corresponding FIR.

In at least one embodiment, the charge value data includes total distance traveled in nautical miles, total elapsed time, and calculated airspace usage charge.

In at least one embodiment, the processor is further configured to: apply error-checking routines in the route string decoding process, wherein the error-checking routines include validating the encoded waypoint data by cross-referencing each waypoint in a given decoded route string with a predefined database.

In at least one embodiment, the plan route data and the plan route line include origin and destination countries derived from an initial waypoint and a terminal waypoint, a flight reference number, and a source timestamp; and wherein the plan route geographical coordinates represent a plurality of waypoints along the plan route line.

In at least one embodiment, the plan route line and the flown route line are geographic representations stored as PostgreSQL-based line strings.

In at least one embodiment, the planned route intersection object includes a plurality of FIRs traversed by the plan route line, a flight reference number, an aircraft type, a source timestamp, and origin and destination countries.

In at least one embodiment, the processor is further configured to retrieve the selected country specific billing function from a repository of country specific billing functions stored.

In at least one embodiment, the server comprises an in-memory database that uses an in-memory queue to manage real-time flight reference queues and a parallel worker process architecture for creating separate workers to determine usage and related calculations for each flight.

In at least one embodiment, the server comprises a relational database to receive a new flight reference number for tracking a new airplane flight and to generate a trigger notification which is used to extract the flight reference number and forward it to the in-memory queue to enable immediate and real-time processing of flight information for the new airplane flight being processed.

In at least one embodiment, upon determination of the new airplane being processed, a worker child process is started.

In at least one embodiment, several worker processes are used to concurrently monitor the in-memory queue for each new flight reference such that when the new flight reference is pushed to the in-memory queue, the new flight reference number is picked up by an available worker process.

In at least one embodiment, each worker process processes usage and related data for a separate airplane flight and maintain real-time synchronization with the in-memory database thereby providing concurrent processing of multiple flight references.

In at least one embodiment, additional worker processes are generated for scaling the server to track and determine usage and related data for a greater number of airplane flights.

In at least one embodiment, the relational database is used to store airspace, navigation, and billing-related data for handling of flight reference processing for a given flight reference number.

In another aspect, in accordance with the teachings herein, there is provided at least one embodiment of a method for determining airspace and airport services usage including costs for a plurality of users for a plurality of airplane flights, the method comprising: providing a server having a communication interface, a processor and a memory storing program instructions for performing the method; communicating with external systems, using the communication interface, to receive from a give airplane flight, a route string and flown navigation data; generating, using the processor, a plan route data by decoding a route string, wherein the plan route data includes plan route geographic coordinates generated by translating encoded waypoint data; generating, using the processor, a plan route line providing a plan route geographic representation of latitude and longitude values based on the plan route geographical coordinates; generating, using the processor, a flown route data by extracting sequential waypoint data from a flown navigation data, wherein the flown route data includes flown route geographic coordinates; generating, using the processor, a flown route line providing a flown route geographic representation of the flown route geographic coordinates; determining, using the processor, a plan route intersection object and a flown route intersection object, wherein the plan route intersection object includes a plurality of plan route intersection coordinates at the points where a plurality of FIR boundaries intersect with the plan route line, and wherein the flown route intersection object includes a plurality of flown route intersection coordinates at the points where the plurality of FIR boundaries intersect with the flown route line; and updating a flight database stored on the memory to include flight reference data, aircraft type data, FIR code, distance covered in a corresponding FIR, and time elapsed in the corresponding FIR.

In at least one embodiment, the method further comprises: selecting, using the processor, a country billing function based on the plurality of FIR boundaries intersected by either a plan route intersection object or flown route intersection object; and determining, using the processor, a charge value data by applying a selected country billing function on data values in an associated intersection object, wherein the selected country billing function is associated to either the plan route intersection object or the flown route intersection object, and wherein the data values include flight reference data, aircraft type data, FIR code, distance covered in a corresponding FIR, and time elapsed in the corresponding FIR.

In at least one embodiment, the charge value data includes total distance traveled in nautical miles, total elapsed time, and calculated airspace usage charge.

In at least one embodiment, the method further comprises: applying error-checking routines in the route string decoding process, wherein the error-checking routines include validating the encoded waypoint data by cross-referencing each waypoint in a given decoded route string with a predefined database.

In at least one embodiment, the plan route data and the plan route line include origin and destination countries derived from an initial waypoint and a terminal waypoint, a flight reference number, and a source timestamp; and wherein the plan route geographical coordinates represent a plurality of waypoints along the plan route line.

In at least one embodiment, the plan route line and the flown route line are geographic representations stored as PostgreSQL-based line strings.

In at least one embodiment, the planned route intersection object includes a plurality of FIRs traversed by the plan route line, a flight reference number, an aircraft type, a source timestamp, and origin and destination countries.

In at least one embodiment, the method further includes retrieving the selected country specific billing function from a repository of country specific billing functions stored.

In at least one embodiment, the server comprises an in-memory database and the method comprises using an in-memory queue to manage real-time flight reference queues and a parallel worker process architecture for creating separate workers to determine usage and related calculations for each flight.

In at least one embodiment, the server comprises a relational database to receive a new flight reference number for tracking a new airplane flight and to generate a trigger notification which is used to extract the flight reference number and forward it to the in-memory queue to enable immediate and real-time processing of flight information for the new airplane flight being processed.

In at least one embodiment, upon determination of the new airplane being processed, a worker child process is started.

In at least one embodiment, several worker processes are used to concurrently monitor the in-memory queue for each new flight reference such that when the new flight reference is pushed to the in-memory queue, the new flight reference number is picked up by an available worker process.

In at least one embodiment, each worker process usage and related data for a separate airplane flight and maintain real-time synchronization with the in-memory database thereby providing concurrent processing of multiple flight references.

In at least one embodiment, additional worker processes are generated for scaling the server to track a greater number of airplane flights.

In at least one embodiment, the relational database is used to store airspace, navigation, and billing-related data for handling of flight reference processing for a given flight reference number.

In another aspect, in accordance with the teachings herein, there is provided at least one embodiment of a computer-readable storage medium storing instructions that, when executed by a processor, cause the processor to perform the method defined by the teachings herein.

In another aspect, in accordance with the teachings herein, there is provided at least one embodiment of a server for determining airspace and airport service usage including costs for airplane flights, the server comprising: a communication interface for communicating with external systems for receiving airspace and airport service usage for the airplane flights; a memory that stores program instructions for determining airspace and airport service usage and costs; and a processor that is operatively coupled to the communication interface and the memory, the processor, when executing the program instructions, being configured to: access the external systems to receive a route string and flown navigation data for a given airplane flight; generate plan route data by decoding the route string, wherein the plan route data includes plan route geographic coordinates generated by translating encoded waypoint data; generate a plan route line providing a plan route geographic representation of latitude and longitude values based on the plan route geographical coordinates; generate flown route data by extracting sequential waypoint data from a flown navigation data, wherein the flown route data includes flown route geographic coordinates; generate a flown route line providing a flown route geographic representation of the flown route geographic coordinates; determine a plan route intersection object and a flown route intersection object, wherein the plan route intersection object includes a plurality of plan route intersection coordinates at the points where a plurality of FIR boundaries intersect with the plan route line, and wherein the flown route intersection object includes a plurality of flown route intersection coordinates at the points where the plurality of FIR boundaries intersect with the flown route line; select a country billing function based on the plurality of FIR boundaries intersected by either the plan route intersection object or the flown route intersection object; and determine charge value data by applying the selected country billing function on data values in an associated intersection object, wherein the selected country billing function is associated to either the plan route intersection object or the flown route intersection object, and wherein the data values include flight reference data, aircraft type data, FIR code, distance covered in a corresponding FIR, and time elapsed in the corresponding FIR.

In another aspect, in accordance with the teachings herein, there is provided at least one embodiment of a device for determining airspace and airport services costs, the device comprising: a processor configured to: generate a plan route data by decoding a route string, wherein the plan route data includes plan route geographic coordinates generated by translating encoded waypoint data; generate a plan route line providing a plan route geographic representation of latitude and longitude values based on the plan route geographical coordinates; generate a flown route data by extracting sequential waypoint data from a flown navigation data, wherein the flown route data includes flown route geographic coordinates; generate a flown route line providing a flown route geographic representation of the flown route geographic coordinates; determine a plan route intersection object and a flown route intersection object, wherein the plan route intersection object includes a plurality of plan route intersection coordinates at the points where a plurality of FIR boundaries intersect with the plan route line, and wherein the flown route intersection object includes a plurality of flown route intersection coordinates at the points where the plurality of FIR boundaries intersect with the flown route line; select a country billing function based on the plurality of FIR boundaries intersected by either a plan route intersection object or flown route intersection object; and determine a charge value data by applying a selected country billing function on data values in an associated intersection object, wherein the selected country billing function is associated to either the plan route intersection object or the flown route intersection object, and wherein the data values include flight reference data, aircraft type data, FIR code, distance covered in a corresponding FIR, and time elapsed in the corresponding FIR.

It will be appreciated that the foregoing summary sets out representative aspects of embodiments to assist skilled readers in understanding the following detailed description. Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the embodiments described herein and to show more clearly how they may be carried into effect, reference will now be made, by way of example only, to the accompanying drawings which show at least one example embodiment, as now described.

FIG. 1 is a block diagram of an example ANSP airspace and airport usage management system in accordance with an embodiment, in accordance with the teachings herein.

FIG. 2 is a block diagram of an example embodiment of an airspace and airport usage management system device, in accordance with the teachings herein, where the device includes a processor and a memory.

FIG. 3 is a flowchart of an example embodiment of an airspace and airport usage management method, in accordance with the teachings herein.

FIG. 4 is a display of an example embodiment of a user interface for an ANSP system, in accordance with the teachings herein.

FIG. 5 is a display of an example embodiment of another user interface for an ANSP system, in accordance with the teachings herein.

FIG. 6 is a flowchart of an example embodiment of another airspace and airport usage management method.

FIG. 7 is a display of an example embodiment of a flight route decoding interface.

FIG. 8 is a display of an example embodiment of an Account Relationship and Revenue Management (ARM) dashboard.

The skilled person in the art will understand that the drawings, described below, are for illustration purposes only. The drawings are not intended to limit the scope of the applicants' teachings in any way. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the programmable computers may be a server, network appliance, embedded device, computer expansion module, a personal computer, laptop, personal data assistant, cellular telephone, smart-phone device, tablet computer, a wireless device or any other computing device capable of being configured to carry out the methods described herein.

Program code may be applied to input data to perform the functions described herein and to generate output information. The output information is applied to one or more output devices, in known fashion.

Each program may be implemented in a high-level procedural or object-oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmissions or downloadings, magnetic and electronic storage media, digital and analog signals, and the like. The computer useable instructions may also be in various forms, including compiled and non-compiled code.

In a first aspect, the inventors have realized that traditional management systems used by ANSPs and airports are highly fragmented, with data collection and processing spread across numerous business centers, platforms and databases. This results in data silos, where information related to air traffic control, flight paths, airspace usage, airport services, and aircraft specifications is often stored in disparate systems. These isolated systems (often 3^{rd} party secured systems) cannot be customized or adapted and make such data inaccessible to the Finance department. Where available, it may require manual intervention to compile and process the necessary data, leading to operational delays and increasing the likelihood of human error in tracking airport and airspace usage. The lack of integration between these data systems limits the ability to provide billing and revenue recovery processes in an efficient manner. These challenges are confounded by the sheer amount of data in these siloed systems, where high volumes of complex data generated by flight operations and airport activity must be efficiently managed.

In a second aspect, the inventors have realized that another inefficiency in existing systems stems from the inability of conventional approaches to manage airspace usage data. The inventors have realized that incorporating both real-time flown data and flight plan data greatly increases the efficiency and accuracy of these systems. This avoids the shortcomings of many conventional revenue management systems that mainly rely on filed flight plan or post-flight data collection methods, where information is retrieved after the flight has landed and the two invariably cannot be matched, leading to inefficiencies, potential errors and delaying the overall billing process. The inventors have realized that by using real-time data processing for real time flown data and flight plan data and given the inherent variations between the two, the ability to dynamically calculate charges for services consumed during flight, such as air navigation, traffic management, and airspace use is possible leading to more efficient and accurate tracking of airspace usage. This ensures that disputes by airline customers do not arise in the first place and if they do, then both sets of data are available in order to address any claims thereof. Otherwise, with conventional systems, there is a delay in data processing that can restrict cost recovery efforts and lengthen the dispute resolution process when there are discrepancies in charges since airports and ANSPs may not promptly issue invoices and resolve disputes which negatively impacts cost-recovery efforts and operational timelines.

In a third aspect, the inventors have also realized that the complexity of calculating airspace usage fees, especially for international flights that traverse multiple chargeable airspaces, is compounded by the inefficient geospatial calculations that are used by conventional systems. Existing systems often struggle to accurately calculate flight paths or to account for entry and exit points as well as vertical service volumes segregating the Terminal Area as airplanes climb and descend from the airport environment into the higher Enroute phase and to in multiple chargeable zones. These systems typically do not use scientific distance calculations and instead rely on simplified assumed pre-calculated distances, which may fail to provide the precision needed for accurate billing. Further, another input parameter to consider, which is the Maximum Certified Takeoff Weight of the aircraft attributed by the manufacturer to each aircraft (comparable to a VIN number for a car) is either assumed or a generic value leading to disputes. As a result, ANSPs and airports are frequently left with incomplete or inaccurate data, affecting both the accuracy of charges and the ability to collect revenue from airlines.

In a fourth aspect, the inventors have realized that current systems also lack the computational efficiency necessary to process the growing volume of flights and services associated with modern air travel. With flight operations becoming more frequent and complex, current systems find it increasingly difficult to scale their processing capabilities. The inability to rapidly process large datasets including from GPS-based flight tracking data to passenger service utilization, restricts the ability to track airport and airspace usage as well as to generate timely invoices and accurately charge for services consumed. This not only delays revenue collection but also introduces errors, increases administrative costs for ANSPs and airports as they work to reconcile data discrepancies or address billing disputes.

In a fifth aspect, the inventors have realized that in addition to processing speed inefficiencies, traditional/conventional systems lack advanced analytics and automated decision-making capabilities. Modern air traffic control and airport operations generate a large amount of data that may be leveraged to optimize billing (usually their sole source of revenue) and customer management processes. However, existing systems do not effectively utilize this data, relying instead on manual, formulaic approaches to cost calculation that do not take into account dynamic variables, such as time of day, flight delays, or changes in service usage during a flight. The absence of real-time analytics in current systems makes it difficult to apply differential billing policies, go about budgets, do reporting or to adjust charges based on the unique circumstances of each flight.

In a sixth aspect, the inventors have realized that current systems provide limited visibility and control to aircraft operators and service providers, resulting in poor customer relationship management (CRM). Without an integrated platform for real-time access to billing data, operators face challenges in tracking airspace and/or airport usage, the status of their invoices, resolving disputes, and understanding the factors contributing to charges. The lack of transparency and customer engagement tools further compounds inefficiencies in dispute resolution and payment processing, leading to a protracted revenue cycle for service providers.

To address these issues, the inventors have developed systems, devices, and methods for airspace and airport services management usage have been developed. Moreover, the systems and methods are provided on an enterprise basis using software as a service to make this service available to ANSPs and airports around the world. This greatly increases the challenge associated managing large amounts of data in an effective manner as the enterprise system has been greatly scaled to be used by ANSPs and airports around the world. In at least one embodiment, the inventive systems and methods described herein provide for real-time processing of geospatial data and flight information, enabling accurate and dynamic cost calculations based on both planned and flown flight data in a highly efficient and accurate manner. By integrating data from multiple sources, including real-time flight tracking, airspace boundaries, and country-specific billing regulations, the system provides a dynamic, cost determination process that is tailored to a variety of different jurisdictions and countries. The system avoids the need for manual data handling, tracks airspace and airport usage in real-time, improves billing accuracy, and provides for timely invoice generation to improve operational efficiency for Air Navigation Service Providers (ANSPs) and airports.

In at least one embodiment, the system is configured to receive geospatial data related to airspace boundaries. The geospatial data includes point-based data such as Flight Information Regions (FIRs), Upper Information Regions (UIRs), latitude, longitude, and sequence numbers. The geospatial data may include additional information for accurately mapping out the relevant airspace boundaries for flight operations and billing purposes.

The system further generates a plurality of geospatial polygons based on the received geospatial data. These polygons define the boundaries of the airspace regions, enabling precise calculations of flight routes and intersections with specific airspaces. The generation of geospatial polygons allows for the dynamic representation of airspace that may be used for flight planning and cost determination.

In at least one embodiment, the system is configured to receive a plurality of route strings. The system processes route strings representing a series of waypoints that define a planned flight path. The system processes/decodes the route strings to generate geographic coordinates, such as latitude and longitude values. The system processes route strings to generate geographical coordinates, constructs planned path data for planned routes and retrieves real-time coordinates for flown paths. The feature allows for the translation of planned flight routes into a format that can be processed for cost and operational analysis and support airspace usage monitoring and billing functions.

In at least one embodiment, the system is configured to process planned and flown flight routes that may enter and exit a given charging airspace, such as a Flight Information Region (FIR), one or more times within a single flight. The feature supports accurate overflight charge computation in complex routing scenarios, such as when a route traverses an FIR in multiple segments. The feature is supported by the system's ability to recognize multiple entry and exit points across a single FIR polygon and compute associated metrics accordingly. The system includes a geospatial intersection processing module that recognizes route-FIR intersections based on true geospatial features rather than assumed paths or pre-processed flight planning outputs. In at least one embodiment, the geospatial intersection processing module provides precise geographic information system (GIS)-based processing. The GIS approach assigns each waypoint in the flight path a corresponding geometric (GEOM) value, allowing the system to perform accurate spatial intersection calculations. The processing methodology differs from conventional systems that rely on approximated distances or pre-determined FIR overlaps. Instead, the system dynamically computes real intersections in real-time or near real-time using actual geographic data. The system is further configured to detect the first entry and final exit points for a given FIR traversal by analyzing the sequential path data for either or both planned or flown paths. The process enables the system to determine whether a flight qualifies as an overflight, based on whether the FIR was exited after being entered. The determination is made through sequential comparison of geospatial coordinates along the route against the polygonal boundaries of the FIR, stored in memory 114 or external data storage 104. In scenarios where a flight path intersects the same FIR multiple times, the system is configured to accumulate multiple distance segments within the FIR to generate a total distance flown. Each segment, from entry to exit, is identified and measured using geodesic distance calculations, such as the Haversine or colatitude method, as previously described. The resulting distances are aggregated to compute a total FIR-specific distance, which is used in subsequent charge calculations. The feature provides that billing reflects actual airspace usage across all portions of the FIR traversed.

The above feature is beneficial for scenarios where planned route data (PLAN) alone may not have otherwise been sufficient for air traffic control (ATC) units to apply charges. In at least one embodiment, the system correlates the actual FIR traversal data with the planned route string data. By decoding the route string into structured plan route data, the system is able to detect FIR entries and exits that would not be visible through conventional ATC processing alone. The feature resolves a core challenge in current airspace charging workflows, enabling billing authorities to apply appropriate overflight charges even when the flight is only partially tracked or controlled.

Additionally, the system is configured to generate flight path data based on the decoded latitude and longitude values. By converting the route strings into flight path data, the system provides for management of flight information such that the accurate data is available for determining navigation and service costs.

The system may determine a plurality of flown coordinates from real-time flight data to construct flight flown data. This feature allows the system to track actual flight paths to determine real-time deviations or changes from the planned route.

In at least one embodiment, the system assigns either the flight path data or the flight flown data as the selected route data, to accurately determine airspace usage and distance traveled, depending on the requirements of the country-specific billing function. The system determines a plurality of intersection coordinates based on intersections between the geospatial polygons and the selected route data. These intersection points, which mark where a flight crosses into different airspaces, can be processed for calculating overflight charges and determining the services consumed within the airspace.

In at least one embodiment, the system is further configured to account for the vertical dimensions of a Flight Information Region (FIR) when determining airspace usage. Certain FIRs may have altitude-based operational limits, such as an upper airspace starting from a defined flight level (e.g., FL240 or 24,000 feet). The vertical boundaries are represented within the system as metadata associated with each FIR polygon stored in memory 114 or the external data storage 104. The processor 112 retrieves and applies altitude constraints during FIR intersection calculations. When processing either planned or flown route data, the processor 112 evaluates the horizontal geographic coordinates of entry and exit points and their altitude values. The feature allows the system to distinguish between traversals occurring in upper airspace versus those in lower or domestic segments. In at least one embodiment, the system determines whether a flight segment crosses into or out of vertically defined FIR space. For example, if a flight descends into an airport within the Caribbean region, the system detects the transition from upper to lower airspace, and attributes FIR charges accordingly. Similarly, during climb-out, each vertical transition is assessed based on geospatial and altitude data retrieved from the navigation data or real-time aircraft telemetry.

The system processes a plurality of properties, such as a distance value and a time value corresponding to the intersection coordinates and the selected route data. The feature provides for calculation of air usage/distance travelled so that navigation charges and other costs associated with airspace and airport services based on the distance flown and the time spent in chargeable airspace can be determined.

The system may process route strings to generate geographical coordinates, construct planned path data for planned routes and retrieve real-time coordinates for flown paths. Intersection coordinates within geospatial polygons can identified to determine the specific distance and time values, allowing for billing based on the selected route type. The system may implement an accurate methodology for leveraging flown routes to determine flown distances, enabling the generation of error-free invoices for air traffic control (ATC) and providing reliable verification for airline customers. The system may also provide a baseline for claims and dispute management, ensuring transparency and consistency in cost calculations across various billing and operational processes.

In at least one embodiment, the system maintains a curated dataset comprising Maximum Takeoff Weight (MTOW) values for aircraft. The MTOW data is stored in a structured data repository in memory 114 or external storage 104. The dataset includes values at both the aircraft model level (e.g., Boeing 737-800) and the tail-specific level, where each aircraft is uniquely identified by a registration number. The processor 112, when executing the charge calculation module, retrieves the applicable MTOW based on the aircraft tail number recorded in the flight data. The use of tail-specific MTOW values improves accuracy in billing where regulatory formulas are sensitive to aircraft weight. The system can also maintain an aircraft ownership database, which maps individual aircraft to their respective operators or fleet owners. The ownership data is referenced during invoice generation. The processor 112, when executing the Operations Management System (OMS) dashboard or a Claims module, aggregates flight records associated with an operator and compiles a single consolidated invoice. The feature supports a billing cycle-level view for the entire fleet, improving traceability and simplifying reconciliation for both the service provider and the airline or operator.

Accordingly, in one aspect, at least one embodiment of a system and related method is provided herein where route strings representing flight plan data is decoded to generate a first set of geographical coordinates to construct planned path data for planned routes, and real-time coordinates are received to determine a second set of geographical coordinates related to actual flown path data. Intersection coordinates between coordinates of one of the two sets of geographical coordinates with geospatial polygons are identified to determine specific distance and time values for actual airspace usage, which may be used for various purposes including billing based on a selected route type in accordance with jurisdictional requirements.

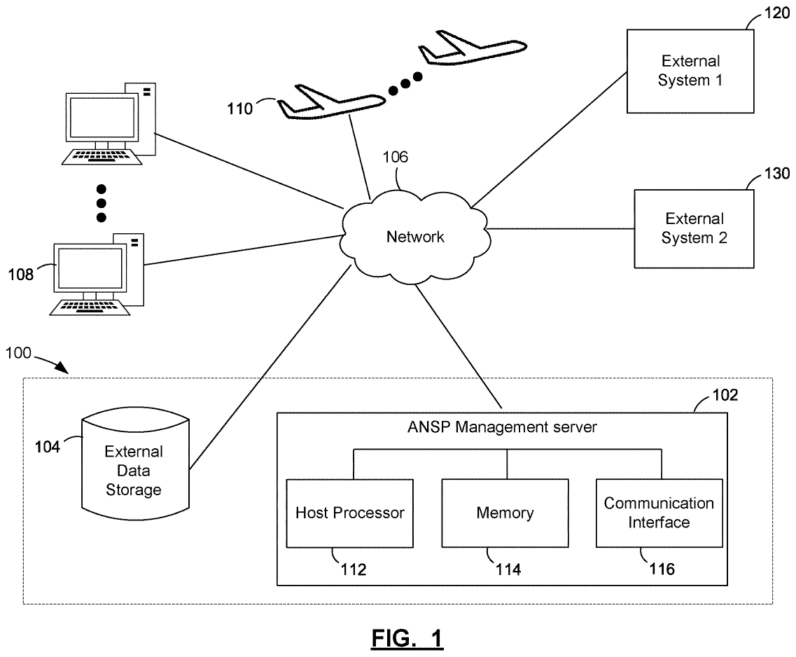

Reference is first made to FIG. 1, which illustrates an example embodiment of an Airport and ANSP management system 100 that includes an ANSP management server 102 and data storage 104. The server 102 is communicatively coupled to a communication network 106 that connects multiple components, providing for data transfer and communication. The ANSP management server 102 executes software which, when executed, configures the server 102 to perform various functions including data analysis and risk assessment that can be provided to various users which may each represent an ANSP or an airport. For example, several user terminals 106 may be used by a user or an administrator for monitoring airspace and/or airport usage and interacting with the ANSP management server 102 via the network 106. The user terminals/user devices 108 represent electronic devices operated by a user who is subscribed to receive data and services from the server 102. Various externals systems such as external systems 120 and 130 are accessible by the ANSP management server 102 via the network 106 from where data access is made, allowing the server 102 to retrieve relevant information. The server 100 may also be in communication with various aircraft such as aircraft 110, which is configured to send live data, such as real-time flight path information, speed, altitude, and other flight-related parameters. The live data is transmitted through the network 102 to the ANSP management server 102, enabling dynamic updates and accurate cost calculations based on the aircraft's actual route and flight conditions.

The system representation shown in FIG. 1 is provided as an example embodiment. There may be variations in the combination or number of such components, and in some cases, a single device may provide the functions of multiple components. For example, while FIG. 1 shows two external systems 120, 130, the server 102 may be in communication with fewer or greater number of such external systems over a wide geographic area via the network 102. Furthermore, while the external systems 120 and 130 are shown as separate components, in some cases, they can be the same devices performing both data provision and reception functions.

The ANSP management server 102 includes a processor 112, a data storage (memory) 114 and a communication component 116. The ANSP management server 102 can be implemented with more than one computer device/server distributed over a wide geographic area and connected via the network. The processor 112, data storage 114 and communication component 116 may be combined into a fewer number of components or may be separated into further components. The ANSP management server 102 is configured to track airspace and airport usage in real-time or near real-time to allow for a variety of actions to be taken such as to calculate overflight and terminal usage based on flight data, airspace boundaries, and country-specific regulations (e.g., formulations). The term “overflight” refers to an airplane flying through an FIR region and not landing.

The processor 112 can be implemented with any suitable processor, controller, digital signal processor, graphics processing unit, application specific integrated circuits (ASICs), and/or field programmable gate arrays (FPGAs) that can provide sufficient processing power for the configuration, purposes and requirements of the device 104. The processor 112 can include more than one processor with each processor being configured to perform different dedicated tasks.

The processor 112 is configured to control the operation of the server 102. For example, the processor 112 executes instructions to manage the retrieval of flight data from external systems, providing continuous updates and precise data acquisition. The processor 112 can also extract relevant information by applying predefined rules to categorize the data, such as waypoints, FIR boundaries, and country-specific billing details. Furthermore, the processor 112 can be configured to execute algorithms to analyze this categorized data, applying formulas to calculate overflight and terminal usage and related charges. Since the server 102 can be communicating with a number of user devices 108, which may be around the world, and also receiving a large volume of data from the external systems 120, 130 as well as the aircraft 110 to provide data and services to the users in real-time or near real-time, via a software as a service model, the server 102 is configured to operate in an efficient manner by reducing computer resource usage and reducing processing time.

The communication component 116 provides for communication between the device 104 and various external systems and devices. For example, the communication component 116 can receive flight data inputs from external systems 120, 130, including aviation databases and airport management systems via APIs. These input signals may include data such as flight routes, aircraft weight, and airspace usage details. The processor 112 processes the input data, extracting and categorizing it according to predefined tags, such as FIR entry and exit points. The processor 112 can also perform validation checks to ensure data accuracy and completeness before executing usage/cost calculation algorithms based on the received information.

The communication component 116 may be a network device and/or radio that allows for communication with the network 106. Accordingly, the communication component 116 may also include an interface to one or more of an Internet, Local Area Network (LAN), Ethernet, Firewire, modem, fiber, or digital subscriber line connection. Various combinations of these elements may be incorporated within the communication component 116.

The data storage 114 can include RAM, ROM, one or more hard drives, one or more flash drives, or some other suitable data storage elements such as disk drives. The data storage 114 can store the extracted and processed data. The data storage 114 can also store the instructions executed by the processor 112. Additionally, the data storage 114 can maintain logs of all flight records, calculations, route data, and updates.

The external systems 120, 130 may include flight plan databases, aircraft tracking systems, weather information systems, and airport service databases. The external system 120 can be associated with a flight planning system, providing access to detailed route strings, flight paths, and FIR intersection data used for calculating overflight usage and charges. The external system 130 can be connected to airport management or ground service systems, supplying real-time information about services used by the aircraft, such as landing, parking, and ground handling, which may be used for determining terminal usage and associated charges.

The network 106 can include any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between, the server 102, the external systems 120 and 130, aircrafts 110, the external data storage 104, the aircraft 110 and the user terminals 108.

The user terminals/devices 108 can include a processor and memory, and may be a computer, tablet, workstation, portable computer, mobile device, personal digital assistant, laptop, or any combination of these devices. Separate user terminals 108 may exist for multiple users, including end-users, assessors, and administrators.

The server 102 is configured to receive, at the host processor 112 via the network 102, a plurality of input signals from a plurality of external systems 120 and 130. These input signals correspond to a client identifier. The plurality of input signals generates a corresponding first record.

For ANSP users, the user terminal 106 may provide an interface to input or review flight data, such as planned or flown routes, and manage usage (e.g., cost) estimation for overflight and terminal charges. ANSP users can also use the terminal to monitor real-time updates on billing calculations, view detailed breakdowns of charges for specific flights, and make adjustments to billing parameters based on updated regulations or service fees. Administrators within a given ANSP can access the terminal 106 to oversee system performance, manage user roles and permissions.

The processor 112 is configured to receive geospatial data related to airspace boundaries, the geospatial data comprising geographical point-based data including Flight Information Regions (FIRs), Upper Information Regions (UIRs), latitude, longitude, and sequence numbers. Further, the processor 112 is configured to generate a plurality of geospatial polygons based on the geospatial data to define airspace boundaries. Some of the various data and geospatial polygons may be stored in databases at memory 114 for more efficient retrieval or alternatively on external data storage 104.

In at least one embodiment, the processor 112 is configured to manage the geospatial processing and representation of airspace boundaries, including Flight Information Regions (FIRs), Upper Information Regions (UIRs), and other relevant airspace data. The processor 112 executes software instructions to generate, maintain, and process geospatial polygons that define these boundaries, enabling the precise visualization and calculation of airspace usage for cost determination. The data required for this process, such as FIR and UIR boundary information, may be retrieved and stored in the data storage 114.

In at least one embodiment, the processor 112 retrieves boundary data, including geographic points like FIR identifiers, latitude, longitude, and sequence numbers, from the external data storage 108 or other connected external systems 120, 130. The processor 112 may be configured to process the data to generate geospatial polygons, which are used for flight route and cost calculations. Additionally, the processor 112 provides for identifying and correcting any discrepancies such as gaps, overlaps, or misalignments based on updated geographic data. Updates to boundary data can be performed automatically, with the processor 112 retrieving new or missing data and regenerating the polygons.

In at least one embodiment, the processor 112 is configured to retrieve FIR boundary data from the external data storage 108 or connected external systems 120, 130. The retrieved data includes FIR identifiers, latitude and longitude coordinates, and associated sequence numbers. The processor 112 processes the data to generate geospatial polygons representing FIR boundaries. The polygons are constructed and stored in memory 114 as part of an initialization process. The system is configured to draw and freeze the FIR boundaries upon generation. The initial geospatial drawing accounts for known gaps and overlaps, which exist due to variations in State-published coordinates. The processor 112 includes logic to preserve these nuances in the static FIR definitions, preventing frequent redraws. A redraw or regeneration of FIR polygons can be triggered when a State formally changes its boundary definition, affecting its own FIR and potentially those of adjoining States. In such cases, the communication interface 116 retrieves the updated data, and the processor 112 reprocesses the affected boundaries.

In an embodiment, the communication interface 116 (also referred to as communication component) of the server 102 provides for interaction with external systems 120, 130 for the retrieval of data, such as updated FIR definitions or waypoints. The processor 112 processes the data to maintain up-to-date airspace boundaries. In the event of discrepancies between FIR polygons of neighboring regions, the processor 112 executes geospatial tools to resolve gaps or overlaps, for a seamless representation of the airspace. The updated airspace boundaries and geospatial polygons may be stored in the data storage 114 for efficient retrieval for future processing and visualization.

In at least one embodiment, the processor 112 provides for the continuous maintenance of FIR and UIR boundaries by executing automatic update processes that adjust the points defining the polygons. For example, the processor 112 may be configured to retrieve new or missing points from reliable geospatial data sources, reorder or replace the affected points, redraw the polygons, and store the updated polygonal information in memory 114 or storage 104. The updates may occur based on predefined scheduling or data changes retrieved from external systems 120, 130, such that the server 102 is operating with the most current and accurate data.

Accordingly, in at least one embodiment there is provided a system and method are disclosed for decoding flight route data that has been previously concatenated and compressed, comprising an API configured with backend software that configures at least one processor to interpret and reconstruct a sequence of individual waypoints from an encoded flight route. A decoding algorithm is used to parse and expand abbreviated route formats, including region-specific constructs such as the North American Route Program (NARs) and dynamic routing structures like the North Atlantic Tracks (OTS), which are assigned a single-letter identifier (e.g., Track Z) that changes daily based on waypoint composition. By processing these encoded routes, the system enables accurate retrieval and reconstruction of the original waypoint sequence, facilitating efficient flight path analysis and data interpretation.

In at least one embodiment, for managing waypoints and restricted airspace polygons, the processor 112 retrieves new waypoint data from external systems 120, 130, such as aircraft live data 110. The processor 112 processes the data by converting latitude and longitude coordinates into geospatial formats, which are then stored in the data storage 114 and/or the data storage 104. The operation provides that the waypoints and restricted airspace polygons are accurately represented and integrated into the overall airspace boundaries used for airspace usage and distanced traveled which may then be used for other purposes such as determining more routes for more efficient fuel usage by airplanes as well as performing cost calculations related to airspace usage.

In at least one embodiment, the processor 112 may further provide for the compliance with international airspace standards by periodically validating the stored geospatial data against the latest international regulations. For example, the processor 112 may be configured to compare stored FIR polygons with updated international standards and filter out irrelevant polygons, such as UIRs or FIRs that are applicable only at specific altitudes, ensuring that only relevant data is used. The validations can be automatically scheduled and managed through the communication component 116, which interacts with external systems 120, 130 to access up-to-date regulations and standards data.

The memory 114 is configured for storage of various data structures to improve computational efficiency of the processor 112 and reduce computer resource footprint needed for performing certain functions. For example, the memory 114 may be used to store a data structure comprising charge calculation parameters. The charge calculation parameters can be referred to as a FIR Calculated Information Table. The FIR Calculated Information Table provides a comprehensive record of flight intersections with various Flight Information Regions (FIRs). The FIR Calculated Information Table is dynamically populated during the execution of the flight information retrieval process by the processor 112. The FIR Calculated Information Table provides a structured repository for details about the flight, including interactions with FIRs, the countries associated with the FIRs, and the calculated charges.

The FIR Calculated Information Table comprises a plurality of data fields representing a feature of the flight's journey and associated airspace usage costs. The data fields include any one or more of: (a) a flight reference number that identifies a flight and links the calculations and FIR intersections to a specific flight instance; (b) FIR code and name, corresponding to designated airspace regions managed by different countries; (c) country, representing the country governing the airspace corresponding to the FIR and providing for the application of country-specific billing formulas; (d) order of intersection, indicating the sequence in which the flight intersects the FIR during its route; (e) distance in nautical miles, measuring the distance traveled within the FIR; cost, indicating the charge incurred for the flight's traversal through the corresponding FIR, calculated using applicable formulas and country-specific parameters; (f) currency, expressing the cost in a configurable currency based on jurisdiction; elapsed time, recording the time spent within the FIR in minutes; and (g) additional path details, which may include waypoints, latitude/longitude path points, and other spatial data used for intersection calculations. In some embodiments, some of these data records may not be needed.

In at least one embodiment, the processor 112 is configured to execute the flight information retrieval process that includes the retrieval, organization, and processing of flight-related data. The process may be directed to flights managed by a selected airline. The flight information retrieval process is directed to populate the FIR Calculated Information Table in the memory 114. For example, the processor 112 may be configured to retrieve flight route data, identifies intersections of flight routes with FIRs, associates the relevant countries, and computes values necessary for billing.

In at least one embodiment, the processor 112 is configured to initiate a flight information retrieval process by querying a database for the flight reference numbers. The database can be an external storage 104 that stores flight plan information. The processor 112 may be configured to identify flights relevant to the target airline and retrieves associated flight navigation data for subsequent processing. The processor 112 then retrieves navigation data from the database. The navigation data includes any one or more of a flight reference number, which identifies the flight and links computations to a specific flight instance; and an aircraft specification data including maximum take-off weight (MTOW) and wingspan and in some case, seating capacity of the aircraft. The aircraft specification data provides details about the model or type of aircraft, which are required for certain country-based billing computations. The navigation data further includes source timestamp to represent the timing information associated with the flight, including the time of intersection and overflight. The navigation data further includes a route string representing the planned route of the flight in a preset format. The route string includes information about waypoints and supports the reconstruction of the flight's planned trajectory for further analysis. Additionally, the navigation data includes recorded flight data. The recorded flight data includes sequential waypoints with geographic coordinates and timestamps that represent the aircraft's actual movement through airspace during its journey. The sequential waypoints represent the actual geographic path of the aircraft. A waypoint is associated with geographic coordinates, including latitude and longitude values that define the spatial location of the aircraft at specific points during the flight. Further, the navigation data includes timestamp data providing for temporal sequencing of the waypoints for accurate construction of the flown route.

The memory 114 may be used to store the extracted flight navigation data, which can then be efficiently processed for airspace usage cost calculations. For example, the processor 112 may be configured to verify that flights not previously processed are selected for processing by cross-referencing the retrieved data against entries already present in the FIR Calculated Information Table in the memory 114. The processor 112 may be configured to filter out flights that have been previously processed, avoiding redundant calculations. The optimization reduces computational overhead and improves system performance by focusing on unprocessed flights. The selected flights are processed further to determine airspace usage costs based on geographic and regulatory parameters.

The processor 112 may process the retrieved flight navigation data, including the flight reference number, aircraft specification data, source timestamp, and route string, to reconstruct the planned trajectory of the selected flight. The reconstructed trajectory is used to determine more accurate airspace travel which may be used for optimizing fuel usage and other purposes such as for calculating intersections with Flight Information Regions (FIRs) and derive associated airspace usage costs.

In at least one embodiment, the processor 112 is configured to generate a plan route data by decoding a route string. The plan route data includes plan route geographic coordinates generated by translating encoded waypoint data.

The processor 112 is configured to generate plan route data by decoding the route string received in a preset format. The processor 112 may receive the route string from the external system 120. The decoding process may include extracting the route string from the navigation data stored in the memory 114. The processor 112 may apply error-checking routines during the decoding process to ensure the integrity of the extracted data. The error-checking routines include validating waypoints by cross-referencing the waypoint in the decoded route string with a predefined database of valid waypoints stored in the external data storage 108. The validation may provide that the waypoints are accurately identified within the global waypoint registry. The error-checking routines further include a geographic continuity check by analyzing sequential coordinates within the decoded route string. The error-checking routines are directed to ensure that the waypoints form a logical and continuous flight route, detecting and addressing anomalies such as abrupt geographic jumps or unreasonably large distances between consecutive waypoints. Additionally, the error-checking routines may include a timestamp synchronization to verify that the source timestamp associated with the route string aligns with the temporal data of waypoints and air traffic configurations.

In at least one embodiment, the processor 112 is configured to decode the route strings comprising sequences of waypoints representing the planned or flown flight path of an aircraft. The processor 112 extracts geographic coordinates from the waypoints, including 3-letter, and 5-letter codes, to construct a continuous flight path. The decoded data is stored in the memory 114 for quick retrieval and further processing. In an embodiment, the processor 112 executes predefined patterns to decode and classify waypoints, such as Standard Instrument Departures (SID), Standard Terminal Arrival Routes (STAR), or Airways and enroute waypoints.

The plan route data, generated by decoding the route string, includes geographic coordinates generated by translating encoded waypoint data. The processor 112 is further configured to transform the plan route data into a structured geographic representation referred to as a plan route line. The transformation includes referring to a database of waypoints stored in the external data storage 108. The processor 112 resolves the waypoint into geographic coordinates, including latitude and longitude values, to create a continuous geographic line. The processor 112 applies geospatial tools to generate the line string. The processor 112 can apply error-checking mechanisms to identify and resolve inconsistencies in the waypoint data.

The processor 112 can integrate the plan route data with features including origin and destination countries. The origin and destination countries are determined by retrieving the geographic coordinates of the initial and terminal waypoints of the plan route and cross-referencing them with country-specific data stored in the external data storage 108.

The processor 112 is configured to generate a plan route line providing a plan route geographic representation of latitude and longitude values based on the plan route geographical coordinates.

The plan route data and the plan route line can be stored in the memory 114 and represent the intended flight path as submitted in the flight plan. The resulting plan route data and the plan route line enable the processor 112 to perform subsequent tasks in airspace management and cost determination. The processor 112 identifies intersections with FIRs along the plan route by comparing the geographic representation of the plan route data with stored FIR boundary data retrieved from the memory 114 or external data storage 108. The processor 112 determines the entry and exit points of the plan route within the FIR, allowing for accurate computation of distances traveled and charges associated with airspace usage. Additionally, the processor 112 determines the origin and destination countries by analyzing the geographic coordinates of the initial and terminal waypoints of the planned route. The processor 112 may cross-reference the coordinates with country-specific data stored in the external data storage 108 to associate the start and end points with the appropriate countries.

The processor 112 is further configured to process the source timestamp extracted from the navigation data to augment plan route data. The source timestamp processing includes factoring the changing air traffic configurations and temporary route adjustments (e.g., NAT tracks) to capture the time-sensitive variations.

The plan route data and the plan route line include geographic coordinates representing the waypoints along the planned flight path, origin and destination countries derived from the initial and terminal waypoints, entry and exit points for the Flight Information Region (FIR) intersected along the planned route, distances traveled within the FIR, and associated metadata such as the flight reference number, source timestamp, and route-specific parameters. The plan route data further includes structured geographic representations, such as line strings, and additional details such as the latitude and longitude of the waypoint.

In at least one embodiment, the processor 112 is configured to generate a flown route data by extracting sequential waypoint data from a flown navigation data. The flown route data may include flown route geographic coordinates. For example, the flown route data may be provided via GNSS coordinates for in real-time or near real-time as a given airplane 110 is in flight. This data may be received from the airplane 110 itself.

The processor 112 is configured to generate a flown route line providing a flown route geographic representation of the flown route geographic coordinates. For example, in at least one embodiment, the flown route data is generated by extracting sequential waypoint data from the navigation data in the external data storage 108. The waypoint data includes sequentially recorded geographic coordinates corresponding to the aircraft's flown path. The processor 112 processes the waypoint data by sorting the waypoints in order of sequence. The sequenced waypoints in the flown route data provide the chronological progression of the aircraft through airspace. The processor 112 arranges the sorted waypoint data into a continuous geographic representation to generate a flown route line. The flown route line provides a geospatial representation of the aircraft's actual trajectory (i.e., the actual flight path that is flown in contrast to the flight plan which may be changed during flight), enabling accurate spatial analysis and airspace cost determinations.

The processor 112 may initialize the flown route coordinates as an empty data structure configured to store geographical data points representing the flown path of the aircraft. The data structure can be developed into a feature collection object, organizing and standardizing the flown route data to enable integration with subsequent geospatial operations. The feature collection object supports the inclusion of multiple data elements, such as latitude and longitude points, to construct a representation of an aircraft's flown route line. The flown route line represents the actual path taken by the aircraft, constructed as a geographic representation of its recorded trajectory.

The processor 112 may be configured to apply error-checking routines during the construction of the flown route line. The error-checking routines may include verifying the geographic continuity of the sequential waypoints to provide that the recorded flight path forms a contiguous line. The processor 112 may also cross-reference the waypoint data against a predefined database of valid waypoints stored in the external data storage 108 to validate the waypoint accuracy.

The flown route data includes sequentially recorded geographic coordinates representing the flown path of the aircraft, arranged into a continuous geographic representation as the flown route line. The flown route data further includes chronological waypoint sequences, latitude and longitude points, and associated metadata such as timestamps. The flown route line can be stored in the memory 114 as a geospatial representation of the aircraft's trajectory to support subsequent operations for identifying FIR intersections, calculating traveled distances, and determining airspace usage charges in a more efficient and accurate manner.

The processor 112 is configured to calculate intersections between the planned and flown route lines and predefined geospatial boundaries, such as Flight Information Regions (FIRs) while determining the airspace usage by the plane 110. The processor 112 processes the plan route line and flown route line, generated from navigation data, to identify entry and exit points within the FIR. The intersection points are analyzed to determine calculation metrics (also referred to as calculation data), including the distance flown within the FIR and the corresponding countries. The processor 112 can apply the calculation metrics or formulas in subsequent processes for calculating airspace usage costs based on country-specific billing formulas.

In at least one embodiment, the processor 112 is configured to determine a plurality of intersection objects comprising a planned route intersection object and a flown route intersection object.

The processor 112 is configured to determine a plan route intersection object and a flown route intersection object. The plan route intersection object includes a plurality of plan route intersection coordinates at the points where a plurality of FIR boundaries intersect with the plan route line. The flown route intersection object includes a plurality of flown route intersection coordinates at the points where the plurality of FIR boundaries intersects with the flown route line.

The planned route intersection object includes the plan route line. The plan route line may refer to a geographic representation stored as a database line string e.g., PostgreSQL-based line string. The planned route intersection object may further include a plurality of FIRs traversed by the planned route, the flight reference number, the aircraft type, the source timestamp, and the origin and destination countries.

The processor 112 is configured to generate the planned route intersection object by analyzing the plan route data and the plan route line. The processor 112 identifies the intersection points with FIR boundaries against the geographic representation of the planned route line. The intersection points are calculated by comparing the geographic coordinates of the plan route line with FIR boundary data retrieved from the external data storage 108. The processor 112 determines the FIRs traversed by identifying the FIR boundaries intersected by the planned route line. The flight reference number, the aircraft type, and the source timestamp included in the planned route intersection object can be retrieved from the plan route data. Alternatively, the data points that may not be present in the plan route data can be retrieved from the navigation data stored in the memory 114 or the storage 108. The origin and destination countries are determined by analyzing the geographic coordinates of the initial and terminal waypoints in the plan route line and cross-referencing the geographic coordinates with country-specific data stored in the storage 108. The origin and destination countries can also be determined by departure and arrival airports.

The flown route intersection object includes the flown route line as a geographic representation of the actual path flown. The flown route intersection object further includes the FIRs traversed, the flight reference number, the type of aircraft, and the source timestamp. Unlike the planned route intersection object, the flown route intersection object may not require additional alignment steps because the sequential waypoints in the flown route data represent the chronological progression of the flight path.

The source timestamp includes the temporal data associated with a flight, representing the specific time at which the flight-related information, such as planned or flown route data, is recorded or applies.

The processor 112 is configured to generate the flown route intersection object by analyzing the flown route data and the flown route line. The processor 112 calculates intersection points by comparing the geographic representation of the flown route line with FIR boundaries stored in the external data storage 108. The processor 112 identifies FIRs traversed by determining where the flown route line intersects the geospatial polygons defining the FIR. The flight reference number, the type of aircraft, and the source timestamp included in the flown route intersection object are retrieved from the flown route data. Alternatively, the data points that may not be present in the flown route data can be retrieved from the navigation data stored in the memory 114 or the storage 108. The processor 112 consolidates the flown route line, intersection points, and associated metadata into the flown route intersection object.

In an embodiment, the processor 112 executes the intersection calculation process by implementing geometric line intersection functions to identify points where the planned and flown route lines intersect with FIR boundaries. For the planned route, the processor 112 computes intersection points between the geographic coordinates of the planned route line and the boundaries of the planned FIRs. Similarly, the processor 112 may calculate intersection points for the flown route by comparing the geographic coordinates of the flown route line with the flown FIRs.

In at least one embodiment, the processor 112 applies a sorting process to the intersection points for sequential alignment along the respective route in the plan route data. The processor 112 calculates the lengths of line segments between consecutive intersection points using geospatial computations, such as lineLength functions, for example, which are applied to the geographic coordinates of the route line. Based on the calculations, the processor 112 orders the points for alignment along the planned route. If the segment lengths are equal, the processor 112 maintains the existing order of the points. The sorted intersection points, including their associated attributes, are stored in the memory 114 for further processing. The sorting process is directed at events where intersection points may not be returned in the correct sequence during the intersection calculations of the plan route data. The processor 112 iteratively processes the pair of intersection points, comparing the calculated segment lengths to determine the correct order. If the segment length of the first pair is shorter than the second, the points are ordered accordingly. Conversely, if the second segment is shorter, the order is reversed. This process provides that intersection points are sequentially aligned for subsequent operations, such as billing calculations, FIR distance measurements, and determining chronological entry and exit points within the FIR. The sorted intersection data is then integrated into the structured intersection objects for consistency across the downstream processes.

The processor 112 stores the processed intersection data as part of the intersection objects. The structured data provides for consistency across multiple steps, facilitating efficient determination of airspace usage as well as application of billing formulas and precise computation of airspace usage costs.

The processor 112 iterates through intersection result(s) in the dataset to process and extract relevant attributes for generating structured intersection objects. The processor 112 generates both the planned route intersection object and the flown route intersection object to include data values such as the FIR associated with the intersection, FIR tag data indicating the airspace over which the flight passes, the FIR name, the corresponding country, and the flight reference number. The planned route intersection object and the flown route intersection object may further include data values such as one or more of: (a) the aircraft's maximum takeoff weight (MTOW), (b) wingspan, (c) aircraft model, (d) the date and time of the intersection, and (e) distances traveled within the FIR in both kilometers and nautical miles. The processor 112 identifies the origin and destination points of the flight and determines the sequence order of intersections along the respective routes. The FIR name and the corresponding country can be determined by matching the intersection points with geospatial data retrieved from the memory 114, which includes FIR boundary definitions and associated metadata. The distances traveled within the FIR are calculated using geospatial computations applied to the geographic coordinates of the intersection points. In at least one embodiment, the processor 112 computes the distances between geographic points on the flight route based on models such as the Haversine formula or the colatitude method, for example. The distance calculation methods account for the curvature of the Earth, providing precise distance calculations used in navigation algorithms and cost determination processes. The distance data is stored in the memory 114 for performing further calculations more efficiently and for reporting. The origin and destination points are derived from the initial and terminal waypoints in the respective route data. The sequence order can be provided using the chronological arrangement of waypoints in the flown and planned route lines.

The planned route intersection object includes origin and destination country data, which can be processed for applying specific billing formulas that depend on State boundaries, including international “high seas” airspace. In contrast, the flown route intersection object is aligned based on the ordered waypoint data and represents the actual trajectory of the aircraft. In an embodiment, the processor 112 identifies departure and arrival airports by retrieving ICAO (International Civil Aviation Organization) or IATA (International Air Transport Association) codes and corresponding geographic coordinates from the memory 114.

In at least one embodiment, the processor 112 generates data points associated to geographic coordinates for the start and end of the segment traversed in the plan route line and the flown route line. The data points are represented as geospatial points, referred to as the start point and end point of the flight segment, respectively. The algorithm calculates the great-circle midpoint for the segment using geospatial calculations and defines this point as the center of the segment.

In at least one embodiment, the processor 112 is configured to generate an intersection result by integrating the planned route intersection object and the flown route intersection object. The intersection result is structured as an array of object(s) representing a single intersection event for a specific flight. The intersection event(s) include information such as the geographic coordinates of the entry and exit points within a specific Flight Information Region (FIR), the associated FIR name and code, and the governing country of the FIR. In some embodiments, additional attributes may include at least one of: (a) the flight reference number assigned as a unique key, (b) the sequence order of the intersection within the flight's path, (c) metrics such as the distance traveled within the FIR in nautical miles and kilometers, as well as (d) the elapsed time in minutes. The processor 112 may also associate aircraft-specific details, including maximum takeoff weight (MTOW) and wingspan, to intersection event(s) for supporting weight-dependent and region-specific charge calculations. The structured intersection results can be stored in the memory 114 and used in subsequent processes for airspace cost determination and regulatory compliance.

In at least one embodiment, the processor 112 is configured to select a country billing function based on the plurality of FIR boundaries intersected by either a plan route intersection object or flown route intersection object.

The processor 112 is configured to determine a charge type and value data by applying a selected country billing function on data values in an associated intersection object. The selected country billing function can be associated to either the plan route intersection object or the flown route intersection object. The data values include one or more of flight reference data, aircraft type data, FIR code, distance covered in a corresponding FIR, and time elapsed in the corresponding FIR.

The processor 112 is configured to determine a charge value data based on a country specific billing function. The processor 112 dynamically selects the relevant route intersection object for calculating airspace usage charges by analyzing the data attributes within the planned route intersection object or the flown route intersection object. An intersection object includes FIR-specific properties such as the FIR code, country, full FIR name, distance covered in nautical miles, and the elapsed time spent within the FIR. The processor 112 determines whether to use the planned route or the flown route data for charge calculations by referencing predefined country-specific billing rules. The billing rules can be stored in a database within the memory 114. The database includes country-specific configurations that identify whether charges for an FIR are based on planned route data or flown route data. For example, the processor 112 correlates FIR tags from the intersection objects with entries in the database to identify billing formulas, such as applying the Eurocontrol formula for European FIRs or other country-specific formulas for non-European FIRs.

The processor 112 can retrieve country specific billing functions from a repository of country specific billing function stored in the memory 114. The function(s) include variables and parameters such as distance, elapsed time, maximum takeoff weight (MTOW), and unit rates specific to the corresponding FIR's country. Upon matching the FIR tag to a function, the processor 112 selects the appropriate calculation method. For example, when a European FIR is identified, the processor 112 applies the Eurocontrol function. For non-European FIRs, the processor 112 may perform a lookup to identify and retrieve the relevant function from the database. In at least one embodiment, the processor 112 is configured to generate ancillary charges for a country-specific formal that do not rely on distance-based calculations. The formulas may include Datalink and ADS-B charges in the Shanwick FIR. The processor 112 may also identify the UK as the parent country for Shanwick FIR and apply two distinct billing formulas for the Oceanic portion of the airspace and another for domestic FIRs under Eurocontrol regulations. The processor 112 can thereafter attribute each charge to the respective collection agency. For example, the ADS-B charge in the Shanwick FIR is collected by Eurocontrol but paid out to the UK in British Pounds sterling. The Communications charge in the Shanwick FIR however is collected by Eurocontrol but paid out to Ireland in Euros.

In at least one embodiment, the processor 112 is configured to dynamically select either the planned route intersection object or the flown route intersection object based on predefined country-specific billing rules stored in the memory 114. Once the appropriate object is identified, the processor 112 retrieves data values such as the FIR code, country, full FIR name, distance covered in nautical miles, elapsed time within the FIR, and aircraft-specific details including maximum takeoff weight (MTOW) and wingspan from the selected object. The processor 112 applies the selected country-specific billing formula to the retrieved data. For example, the Eurocontrol formula computes charges by combining a distance factor, weight factor, and unit rate. The processor 112 calculates the distance factor by dividing the total distance covered within the FIR by 50 and derives the weight factor by normalizing the MTOW. The processor 112 retrieves the unit rate and other applicable coefficients based on the FIR's country and timestamp. In at least one embodiment, the processor 112 processes the retrieved data to generate an airspace usage charge in the FIR's local currency, which the processor 112 converts into a standard currency such as USD using exchange rates stored in the external data storage 108.

In at least one embodiment, the processor 112 generates a charge value data set for the FIR traversed by the flight. The charge value data may include one or more of the FIR code, FIR name, associated country, distance traveled in nautical miles or any distance rule required under each State formula, elapsed time in minutes, the calculated airspace usage charge in the billed currency, and the corresponding currency details (such as US dollars for example). Additional data points include the MTOW, wingspan, and geospatial details such as entry and exit points for the FIR. The charge value data also includes a unique flight reference number, Tail, date of flight which links the computed charges to the specific flight, and timestamp details to ensure unique traceability and temporal alignment of rates. The processor 112 organizes the charge value data into a structured format suitable for integration with downstream billing and reporting processes.

In at least one embodiment, once the selection between the planned or flown route data is made, the processor 112 calculates airspace charges using the data from the selected intersection object. The processor 112 computes the charge value data by applying the retrieved country-specific function to variables extracted from the selected intersection object and supplemental aircraft or flight-specific data. The determination includes processing metrics such as distance traveled within the FIR, elapsed time within the FIR, and MTOW of the aircraft. For example, the processor 112 multiplies the distance in nautical miles by a unit rate specific to the FIR and applies a coefficient based on the MTOW to derive the total charge for the FIR.

The processor 112 may process multiple data variables in the formula application process. The FIR properties extracted from the intersection object may include the FIR code, country, full FIR name, distance covered in nautical miles, and elapsed time within the FIR in minutes. Aircraft-specific properties retrieved from the navigation data may include the MTOW for weight-dependent function, and the aircraft model, which provides additional specifications such as wingspan for applicable functions. Flight-specific properties include the flight reference number, which identifies the flight, and the timestamp of the flight. The timestamp ensures that valid unit rates corresponding to the applicable date range are applied.

The processor 112 stores the calculated charge values in the FIR Calculated Information Table within the memory 114. The Calculated Information Table may include the FIR code, country, elapsed time, distance covered, and computed charge values for the FIR traversed. Additionally, the processor 112 associates the charge values with the flight reference number for traceability and reporting purposes. The processor 112 associates the calculated cost(s) with its corresponding flight reference number, optionally FIR properties (e.g., country, name, and traversal order), and optionally additional data, including one or more of waypoints, elapsed time, and currency conversion details. The table may also include aircraft attributes, such as MTOW and wingspan, which may be used for certain billing calculations. The calculated charges are then integrated into downstream processes for billing, reporting, and regulatory compliance.

The unit rate, specific to the FIR's country and time range, is retrieved from a database within the memory 114. The processor 112 retrieves the MTOW associated with the flight and calculates the distance covered within the FIR using geospatial tools. The geospatial computations include measuring the geodesic distance between the entry and exit points of the FIR, derived from geographic data in the intersection objects. The processor 112 generates the airspace charge in the FIR's charging currency, which can be converted to a standard currency, such as USD, using real-time exchange rates stored in the external data storage 108.

For non-European FIRs, the processor 112 executes the appropriate country-specific function identified based on the country attribute of the intersection object. The function(s) is configured to handle country and FIR-specific billing requirements, such as weight and distance adjustments, fixed overflight charges, and domestic reductions. For example, the country's function uses parameters such as weight, distance, origin and destination countries, and aircraft specifications. The processor 112 may apply a time of arrival or domestic reduction factor for flights that begin and end within that country.

In at least one embodiment, the processor 112 is configured to execute country-specific billing functions stored in memory 114. The functions are configured to support distinct billing methodologies applied by non-European air navigation service providers (ANSPs). The billing functions account for parameters including distance traveled, maximum takeoff weight (MTOW), origin and destination countries, and other aircraft-specific attributes. For certain jurisdictions, the billing function includes predefined charging caps. For example, in one embodiment, the function enforces a distance cap, whereby the total chargeable distance is limited to 1200 nautical miles, regardless of the actual distance traveled within the FIR. The processor 112, upon identifying a country with such a cap policy, overrides the calculated distance with the capped value before applying the charge computation. Additionally, the processor 112 is configured to apply a weight cap as defined in the applicable billing rule. For instance, in the case of India, the billing function includes a MTOW cap of 230,000 kilograms. If an aircraft exceeds this cap, such as an Airbus A380 with a certified MTOW above 500,000 kilograms, the processor 112 substitutes the MTOW with the capped value during calculation. The caps can be integrated into the billing logic and applied automatically during execution of the selected country function. Furthermore, the international flights originating or destined to that country can be charged based on specific landing rates.

In at least one embodiment, the processor 112 generates input variables that may be used by the function application by organizing data from multiple objects. The input variables can be based either on planned route intersection object or flown route intersection object based on the function's requirement. The first object may include universal parameters such as time, total distance traveled in kilometers, distance in nautical miles, and MTOW. The second object may include country-specific attributes such as origin and destination FIR tags, entry and exit points, and aircraft model data. The processor 112 generates the objects to provide required inputs for the selected formula.

The charge value data generated by the processor 112 is stored in the FIR Calculated Information Table in the memory 114. The table can provide a centralized repository for computed charges, associated metrics, and supporting attributes. The processor 112 further ensures that the data is displayed meaningfully by associating the calculated charges with visual and textual attributes such as the sequence order of FIR traversal, distance, geographic data for entry and exit points, and currency conversion details. The user terminal 106 retrieves charge value data for presentation, enabling administrators and stakeholders to review flight-specific costs, validate billing computations, and generate reports.

In at least one embodiment, the server 102 may be configured to implement a three-part workflow that includes an Account Relationship and Revenue Management (ARM) tool, a front-facing Operator Management System (OMS) dashboard, and a Claims module. The device 104 provides for invoice generation and concludes with funds collection in form of a unified pipeline for Air Navigation Service Providers and airlines. The pipeline provides for accurate route charges, streamlines invoice processes with user-friendly features such as color coding and menu-based filters, and manages revenue collection along with claims and bill verification. The processor 112 coordinates the processes and stores operational data in the memory 114, for efficient billing, dispute resolution, and financial reconciliation.

In at least one embodiment, the Operator Management System (OMS) dashboard functions as a dual-use interface, configured to support both operational and financial workflows. The OMS is implemented as a part of the system's user interface layer, linked to distinct backend modules depending on the system mode. The processor 112, when executing software instructions, configures the OMS for use in either an ANSP mode for ANSP to determine charges for airplanes and flights or an airline operator mode in which the airline operator can verify invoices received from various ANPs. The OMS may operate as the primary interface for airline operators. The OMS enables users to view route-based costs, track real-time flight billing data, and manage airspace usage insights. The interface retrieves charge value data and flight records from the FIR Calculated Information Table and cost data storage, displaying information in a structured and visual format. In at least one embodiment, the OMS can be re-purposed as a front-facing customer portal. The OMS allows billing recipients to access invoices, review flight charges, verify billing logic, and initiate claims. The processor 112 coordinates between the OMS and the Claims module to allow for streamlined dispute management and reconciliation.

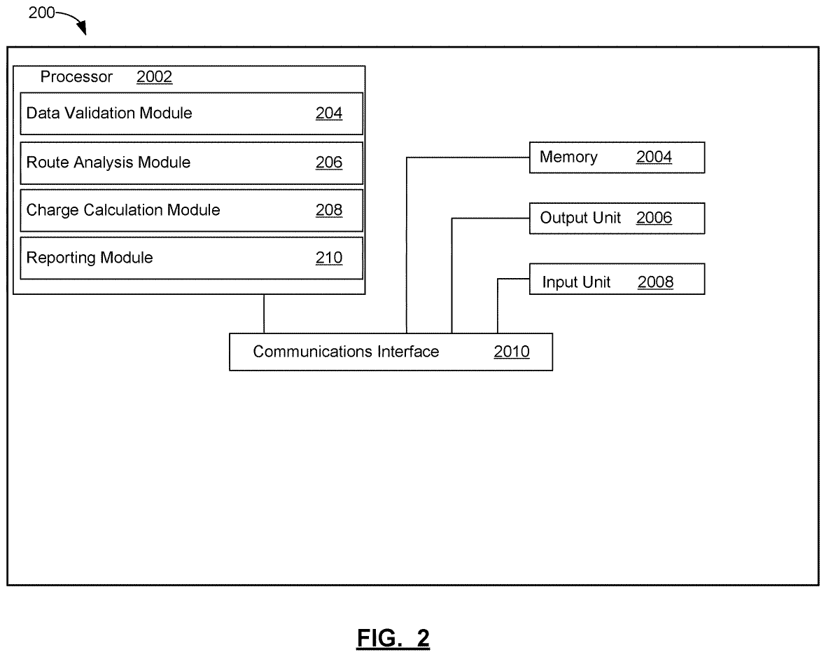

Reference is now made to FIG. 2, which illustrates an example embodiment of a cost determination device 200. The device 200 includes a processor 2002 a memory 2004, an output unit 2006, and an input unit 2008. In at least one embodiment, the cost determination device 200 may be implemented by the server 102.

The processor 2002 is configured to execute various software programs which may include a data validation module 204, a route analysis module 206, a charge calculation module 208, and a reporting module 210. Accordingly, it should be understood that these modules comprise machine-executable instructions or programs that include software instructions that, when executed by the processor 2002, configure the processor 2002 to operate in new ways and perform certain functions which provide various advantages such as improved operational efficiency. It should be noted that the particular implementation of modules in FIG. 2 provides one example, and other embodiments may organize the software instructions differently such that there may be a different number of modules. Furthermore, in alternative embodiments, more than one processor may be used to perform different functions for different modules to improve efficiency.

A communications interface 2010 is also provided and configured to facilitate data exchange between the processor 2002 a memory 2004, an output unit 2006, and an input unit 2008. The communications interface 2010 may also provide a connection to external systems, servers, and user terminals. The communications interface 2006 can include components such as serial ports, USB ports, Ethernet interfaces, or wireless communication modules, supporting protocols like TCP/IP, Wi-Fi, or Bluetooth. The interface 2006 enables the device 200 to communicate with external databases, aircraft systems, and user terminals, ensuring efficient data transfer for real-time processing and cost determination.

The memory 2004 can include volatile memory, such as RAM, or non-volatile memory, such as flash storage or hard disk drives. The output unit 2006 can include a display screen, printer, or any graphical interface that provides visual representations of processed data. e input unit 2008 can include a keyboard, touch interface, or other input devices that enable administrators or users to provide commands, query data, or upload relevant flight and billing configurations.

The memory 2004 is configured to store a data structure comprising charge calculation parameters. The charge calculation parameters can be referred to as an FIR Calculated Information Table. The FIR Calculated Information Table provides a record of flight intersections with various Flight Information Regions (FIRs).

The FIR Calculated Information Table comprises a plurality of data fields representing a feature of the flight's journey and associated airspace usage costs. The data fields include any one or more of a flight reference number; FIR code and name; country; order of intersection; cost; official billing currency; and additional path details, which may include waypoints, latitude/longitude path points, and other spatial data used for intersection calculations.

The software instructions of the data validation module 204, when executed by the processor 2002, configures to processor 2002 to perform a flight information retrieval process that includes the retrieval, organization, and processing of flight-related data. The data validation module 204 includes program instructions to initiate a flight information retrieval process by querying the memory 2004 for the flight reference numbers. The data validation module 204 includes program instructions to identify flights relevant to the target airline and retrieves associated flight navigation data for subsequent processing. The data validation module 204 includes program instructions to retrieve navigation data from the database. The navigation data includes any one or more of a flight reference number, and an aircraft specification data including maximum take-off weight (MTOW) and wingspan. The aircraft specification data provides details about the model or type of aircraft. The navigation data further includes source timestamp and a route string. The route string includes information about waypoints and supports the reconstruction of the flight's planned trajectory for further analysis. Additionally, the navigation data includes recorded flight data. The recorded flight data includes sequential waypoints with geographic coordinates and timestamps that represent the aircraft's actual movement through airspace during its journey. Further, the navigation data includes timestamp data providing for temporal sequencing of the waypoints for accurate construction of the flown route.

In at least one embodiment, the data validation module 204, when executed by the processor 2002, is further configured to access and retrieve aircraft ownership data stored in the system. The ownership data is maintained as a global registry of aircraft owners, mapped to individual aircraft based on their unique tail number or registration code. The database may reside in memory 2004 or be retrieved from external storage 104. The processor 2002 references the ownership data to determine the correct invoice recipient associated with a given flight. Upon identifying the owner linked to the aircraft, the system assigns the invoice to that entity for the relevant billing cycle. The feature addresses the challenge faced by Air Navigation Service Providers (ANSPs) in accurately and promptly identifying who to bill, improving the recovery of dues. In conjunction with the OMS dashboard, which may operate as a front-facing portal when configured for the ANSP mode, the system enables the electronic delivery of invoices. The processor 2002 formats and routes the generated invoice to the identified owner through the OMS, reducing reliance on traditional postal systems. The feature provides for faster, traceable, and centralized invoice communication, significantly improving operational efficiency for both ANSPs and airline operators.

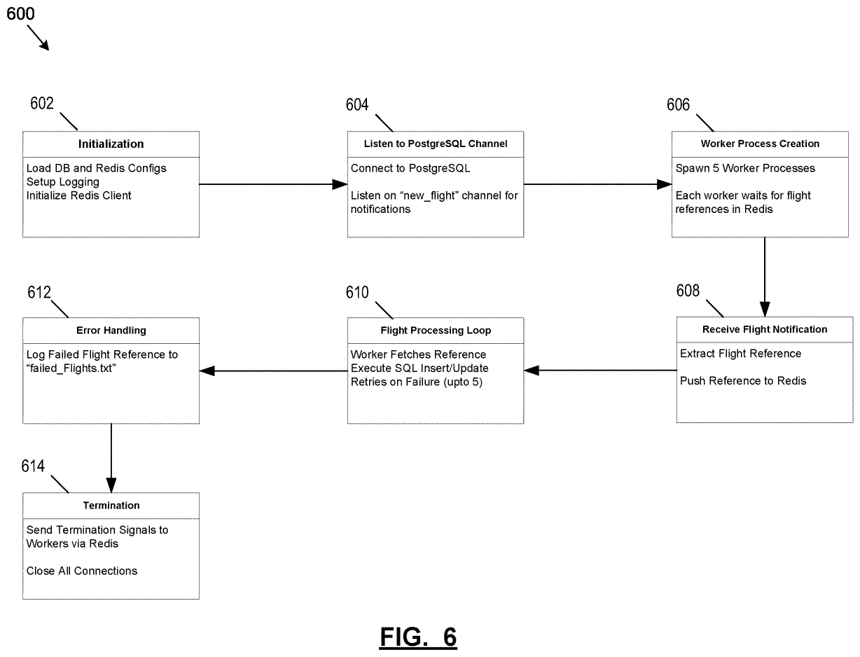

The memory 2004 stores the extracted flight navigation data, which can be processed for airspace usage cost calculations. The data validation module 204 may include program instructions to verify that flights not previously processed are selected for computation by cross-referencing the retrieved data against entries already present in the FIR Calculated Information Table in the memory 114 (as is described in further detail herein such as with respect to FIG. 6, for example).

The data validation module 204 includes program instructions to apply the retrieved flight navigation data, including the flight reference number, aircraft specification data, source timestamp, and route string, to re-construct the planned trajectory of the selected flight. For example, the data validation module 204 includes program instructions to configure the processor 2002 to generate plan route data by decoding the route string received in a preset format. The decoding process includes extracting the route string from the navigation data stored in the memory 2004. The data validation module 204 may include program instructions to apply error-checking routines during the decoding process to ensure the integrity of the extracted data. The error-checking routines include validating waypoints, a geographic continuity check, and a timestamp synchronization.

The plan route data includes individual geographic coordinates generated by translating encoded waypoint data. The data validation module 204 may further includes program instructions to transform the planned route data into a structured geographic representation referred to as a plan route line. The transformation involves consulting a database of waypoints stored in the memory 2004. The processor 2002, when executing the software instructions of the data validation module 204, is configured to resolve\the waypoint into geographic coordinates, including latitude and longitude values, to create a geographic line. The data validation module 204 also includes program instructions for applying geospatial tools to generate the line string. The data validation module 204 can include software instructions to apply error-checking mechanisms to identify and resolve inconsistencies in the waypoint data.

The data validation module 204 may include software instructions to integrate the plan route data with features including origin and destination countries. The origin and destination countries may be determined by retrieving the geographic coordinates of the initial and terminal waypoints of the plan route and cross-referencing them with FIR and country-specific data stored in the memory 2004. The resulting plan route data and the plan route line is stored in the memory 2004. The route analysis module 206 includes software instructions for identifying intersections with FIRs along the planned route by comparing the geographic representation of the planned route with stored FIR boundary data retrieved from the memory 2004. The route analysis module 206 includes software instructions for determining the entry and exit points of the planned route within the FIR, allowing for accurate computation of distances traveled and charges associated with airspace usage. Additionally, the route analysis module 206 may include software instructions to determine the origin and destination countries by analyzing the geographic coordinates of the initial and terminal waypoints of the planned route. The processor 2002, when executing the route analysis module 206, may be configured to cross-reference the coordinates with country-specific data stored in the memory 2004 to associate the start and end points with the appropriate countries.

The route analysis module 206 may further include software instructions to configure the processor 2002 to process the source timestamp extracted from the navigation data to generate plan route data. The source timestamp processing includes factoring the changing air traffic configurations and temporary route adjustments (e.g., NAT tracks) to capture the time-sensitive variations.

The plan route data and the plan route line include geographic coordinates representing the waypoints along the planned flight path, origin and destination countries derived from the initial and terminal waypoints, entry and exit points for the Flight Information Region (FIR) intersected along the planned route, distances traveled within the FIR, and associated metadata such as the flight reference number, source timestamp, and route-specific parameters. The plan route data further includes structured geographic representations, such as line strings, and additional details such as the latitude and longitude of the waypoint. The plan route data and the plan route line can be stored in the memory 2004.

The route analysis module 206 includes software instructions to configure the processor 200 to generate flown route data. The flown route data is generated by extracting sequential waypoint data from the navigation data in the memory 2004. The waypoint data includes sequentially recorded geographic coordinates corresponding to the aircraft's actual path. The route analysis module 206 includes software instructions that can be used to process the waypoint data by sorting the waypoints in order of sequence. The sequenced waypoints in the flown route data provide the chronological progression of the aircraft through airspace. The route analysis module 206 includes software instructions that can be used to arrange the sorted waypoint data into a geographic representation to generate a flown route line. The flown route line provides a geospatial representation of the aircraft's actual trajectory, enabling accurate spatial analysis and airspace cost determinations.

The flown route data includes sequentially recorded geographic coordinates representing the actual path of the aircraft, arranged into a geographic representation as the flown route line. The flown route data further includes chronological waypoint sequences, latitude and longitude points, and associated metadata such as timestamps. The flown route line is stored in the memory 2004 as a geospatial representation of the aircraft's trajectory, supporting subsequent operations for identifying FIR intersections, calculating traveled distances, and determining airspace usage charges.

The route analysis module 206 includes software instructions to configure the processor to calculate intersections between the planned and flown route lines and predefined geospatial boundaries, such as Flight Information Regions (FIRs). The route analysis module 206 includes software instructions to configure the processor 2002 to use the planned route line and flown route line, generated from navigation data, to identify entry and exit points within the FIR. The intersection points are analyzed to determine calculation metrics (also referred to as calculation data), including the distance flown within the FIR and the corresponding countries. The charge calculation module 208 includes software instructions to configure the processor 2002 so that it applies the calculation metrics in subsequent processes for calculating airspace usage costs based on country-specific billing formulas.

The route analysis module 206 includes software instructions to configure the processor 2002 to generate a plurality of intersection objects. The plurality of intersection objects include the planned route intersection object and the flown route intersection object. The planned route intersection object includes the plan route line.

The plan route line may refer to a geographic representation stored as a database line string, for e.g., a PostgreSQL based line string. The planned route intersection object may further include a plurality of FIRs traversed by the planned route, the flight reference number, the aircraft type, the source timestamp, and the origin and destination countries. The route analysis module 206 includes software instructions to configure the processor 2002 to generate the planned route intersection object by analyzing the plan route data and the plan route line. The processor 2002 identifies the intersection points with FIR boundaries against the geographic representation of the planned route line. The intersection points are calculated by comparing the geographic coordinates of the plan route line with FIR boundary data retrieved from the memory 2004. The processor 2002 determines the FIRs traversed by identifying the FIR boundaries intersected by the planned route line. The flight reference number, the aircraft type, and the source timestamp included in the planned route intersection object can be retrieved from the plan route data. Alternatively, the data points that may not be present in the plan route data can be retrieved from the navigation data stored in the memory 2004. The origin and destination countries are determined by analyzing the geographic coordinates of the initial and terminal waypoints in the plan route line and cross-referencing the geographic coordinates with country-specific data stored in the memory 2004. The origin and destination countries can also be determined by departure and arrival airports.

The flown route intersection object includes the flown route line as a geographic representation of the actual path flown. The flown route intersection object further includes the FIRs traversed, the flight reference number, the type of aircraft, and the source timestamp.

The source timestamp includes the temporal data associated with a flight, representing the specific time at which the flight-related information, such as planned or flown route data, is recorded or applies.

The route analysis module 206 includes software instructions to configure the processor 2002 to generate the flown route intersection object by analyzing the flown route data and the flown route line as follows. The processor 2002 calculates intersection points by comparing the geographic representation of the flown route line with FIR boundaries stored in the memory 2004. The processor 2002 identifies FIRs traversed by determining where the flown route line intersects the geospatial polygons defining the FIR. The flight reference number, the type and tail of aircraft, and the source timestamp included in the flown route intersection object are retrieved from the flown route data. Alternatively, the data points that may not be present in the flown route data can be retrieved from the navigation data stored in the memory 2004. The processor 2002 consolidates the flown route line, intersection points, and associated metadata into the flown route intersection object.

In at least one embodiment, the route analysis module 206 includes software instructions to configure the processor 2002 to execute the intersection calculation process by implementing geometric line intersection functions to identify points where the planned and flown route lines intersect with FIR boundaries as follows. For the planned route, the processor 2002 computes intersection points between the geographic coordinates of the planned route line and the boundaries of the planned FIRs. Similarly, the processor 2002 may calculate intersection points for the flown route by comparing the geographic coordinates of the flown route line with the flown FIRs.

In at least one embodiment, the processor 112 is configured to execute the route analysis module 206 to process the intersection points for sequential alignment along the respective route in the plan route data. The sorting process may be similar to the sorting process in the description of FIG. 1.

The route analysis module 206 includes software instructions to configure the processor 2002 to generate both the planned route intersection object and the flown route intersection object to include data values such as the FIR associated with the intersection, FIR tag data indicating the airspace over which the flight passes, the FIR name, the corresponding country, and the flight reference number. The planned route intersection object and the flown route intersection object further include data values such as the aircraft's maximum takeoff weight (MTOW), wingspan, aircraft model, Tail #, the GMT date and time of the intersection in relation to the Departure date and time, and distances traveled within the FIR in both kilometers and nautical miles.

The route analysis module 206 includes software instructions to configure the processor 2002 to generate data points associated to geographic coordinates for the start and end of the segment traversed in the plan route line and the flown route line. The data points are represented as geospatial points, referred to as the start point and end point of the flight segment, respectively.

In at least one embodiment, the route analysis module 206 includes software instructions to configure the processor 2002 to generate an intersection result by integrating the planned route intersection object and the flown route intersection object. The intersection result can be similar to the intersection result in the description of FIG. 1.

In at least one embodiment, the charge calculation module 208 includes software instructions to configure the processor 2002 to determine a charge value data based on a country specific billing function as follows. Accordingly, the processor 2002 may be configured to dynamically select the relevant route intersection object for calculating airspace usage charges by analyzing the attributes within the planned route intersection object or the flown route intersection object. An intersection object includes FIR-specific properties such as the FIR code, country, full FIR name, billing agency name, billing currency, unit rates, distance covered in nautical miles, and the elapsed time spent within the FIR. The charge calculation module 208 includes software instructions to configure the processor to determine whether to use the planned route or the flown route data for charge calculations by referencing predefined country-specific billing rules as follows. The billing rules can be stored in a database within the memory 2004. The database includes country-specific configurations that identify whether charges for an FIR are based on planned route data or flown route data. For example, the processor 2002 may correlate FIR tags from the intersection objects with entries in the database to identify billing formulas, such as applying the Eurocontrol formula for European FIRs or other country-specific formulas for non-European FIRs.

Once the appropriate object is identified, the processor 2002 is configured to operate as follows, when executing the charge calculation module 208, retrieves data values such as the FIR code, country, full FIR name, distance covered in nautical miles, elapsed time within the FIR, and aircraft-specific details including maximum take-off weight (MTOW) and wingspan from the selected object. The processor 2002 applies the selected country-specific billing formula to the retrieved data. The processor 2002 retrieves the unit rate and other applicable coefficients based on the FIR's country and timestamp. In at least one embodiment, the processor 2002 processes the retrieved data to generate an air-space usage charge in the FIR's local billing currency. In at least one embodiment, the processor 2002 generates an airspace usage charge in the FIR's local billing currency, which may be converted for reporting or settlement purposes. Once calculated, the flight data and associated charge information are stored as a historical data object in memory 2004 or external storage 104. The stored object includes all relevant metadata, enabling later recall.

The charge calculation module 208 may include software instructions to configure the processor 2002 to generate a charge value data set for the FIR(s) traversed by the flight as follows. The charge value data includes the FIR code, FIR name, associated country, distance traveled in nautical miles, elapsed time in minutes, the calculated airspace usage charge, and the corresponding currency details. Additional data points include the MTOW, wingspan, and geospatial details such as entry and exit points for the FIR. The charge value data also includes the flight reference number, which links the computed charges to the specific flight, and timestamp details to ensure traceability and temporal alignment of rates. The processor 2002 may be configured to organize the charge value data into a structured format suitable for integration with downstream billing and reporting processes.

The charge calculation module 208 may include software instructions to configure the processor 2002 to store the calculated charge values in the FIR Calculated Information Table within the memory 2004. The stored data is structured to include the FIR code, country, elapsed time, distance covered, and computed charge values for the FIR traversed. Additionally, the charge calculation module 208 may configure the processor 2002 to integrate the charge values with the flight reference number and other relevant attributes for traceability and reporting purposes.

In at least one embodiment, the charge calculation module 208 includes software instructions to configure the processor 2002 to obtain values for input variables that may be used by the function application for organizing data from multiple objects as follows. The input variables can be based either on planned route intersection object or flown route intersection object based on the function's requirement. The first object may include universal parameters such as time, total distance traveled in kilometers, distance in nautical miles or any other distance unit dictated by each FIR formula, and MTOW. The second object may include country-specific attributes such as origin and destination FIR tags, entry and exit points, and aircraft model data. The processor 2002 may be configured to generate the objects to provide required inputs for the selected formula.

The charge value data generated by the processor 2002, when executing the charge calculation module 208, is stored in the FIR Calculated Information Table in the memory 2004. The Calculated Information Table provides a centralized repository for computed charges, associated metrics, and supporting attributes. The reporting module 210 includes software instructions to configure the processor 2002 for displaying the charge value data meaningfully by associating the calculated charges with visual and textual attributes such as the sequence order of FIR traversal, geographic data for entry and exit points, and currency conversion details. The reporting module 210 includes software instructions to configure the processor 2002 to retrieve charge value data for presentation, enabling administrators and stakeholders to review flight-specific costs, validate billing computations, business intelligence insights, budgeting forecasts and generate reports.

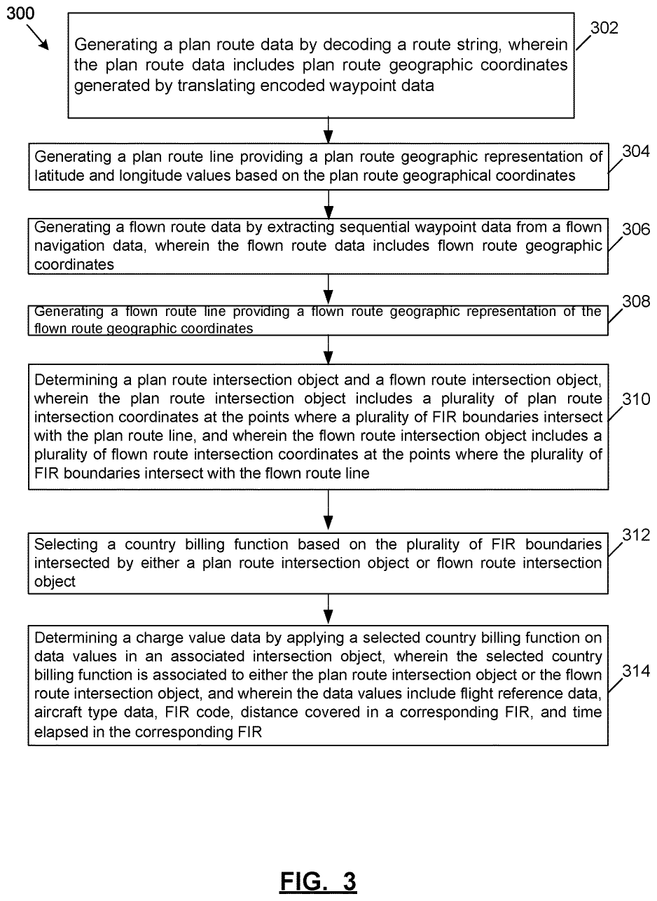

Reference is now made to FIG. 3, which shows a flowchart of an example embodiment of a method 300 for determining airspace and airport services usage for various purposes such as for more efficient cost determination, according to the teachings herein. The method 300 can be implemented by the host processor 112 of the device 104 of FIG. 1.

The method 300 includes retrieving navigation data by a flight reference number from a database. The navigation data includes any one or more of a flight reference number; and an aircraft specification data including maximum take-off weight (MTOW) and wingspan. The aircraft specification data provides details about the model or type of aircraft, which are required for certain country-based billing computations. The navigation data further includes source timestamp, and a route string. The route string represents the planned route of the flight in a preset format. The route string includes information about waypoints and supports the reconstruction of the flight's planned trajectory for further analysis. Additionally, the navigation data includes recorded flight data. The recorded flight data includes sequential waypoints with geographic coordinates and timestamps that represent the aircraft's actual movement through airspace during its journey. The sequential waypoints represent the actual geographic path of the aircraft. A waypoint is associated with geographic coordinates, including latitude and longitude values, that define the spatial location of the aircraft at specific points during the flight. Further, the navigation data includes timestamp data providing for temporal sequencing of the waypoints for accurate construction of the flown route.

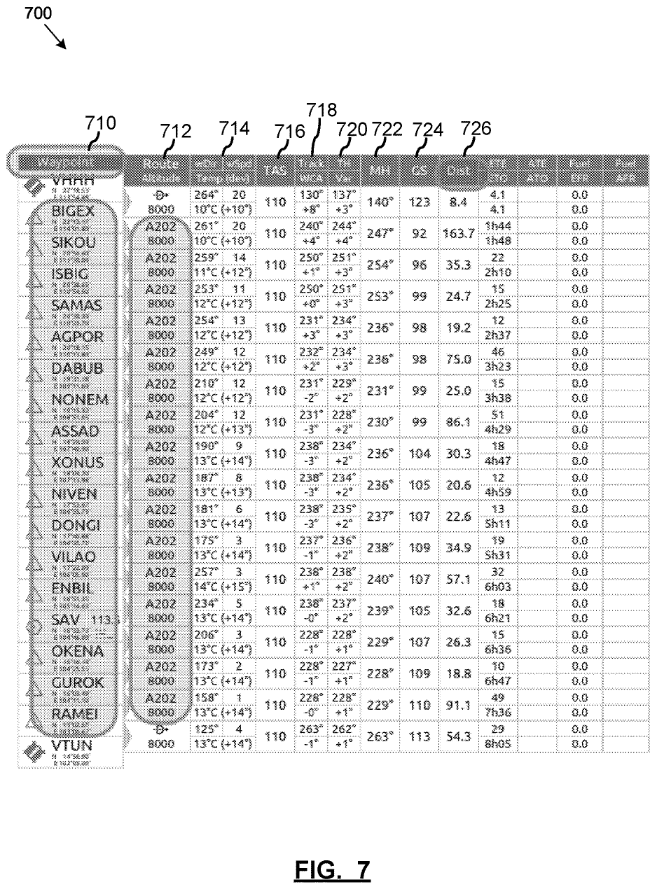

At 302, the method 300 includes generating plan route data by decoding a route string, wherein the plan route data includes plan route geographic coordinates generated by translating encoded Airway waypoint data (e.g. Airway A1 may include multiple individual waypoints concatenated and represented by an airway label, such as “A202” in FIG. 7). The decoding process includes extracting the route string from the navigation data stored in the database. For example, the processor 112 decodes the airway segment into its constituent waypoints and assigns corresponding latitude and longitude values to construct a continuous geographic representation of the planned route. The route string comprises sequences of waypoints representing the planned or flown flight path of an aircraft.

The method 300 may further include applying error-checking routines during the decoding process to ensure the integrity of the extracted data. The error-checking routines include validating waypoints by cross-referencing the waypoint in the decoded route string (as illustrated in FIG. 7) with a predefined database of valid waypoints stored in the external data storage 104. The validation provides that the waypoints are accurately identified within the global waypoint registry. The error-checking routines may further include a geographic continuity check by analyzing sequential coordinates within the decoded route string. The method 300 provides that the waypoints form a logical and continuous flight route, detecting and addressing anomalies such as abrupt geographic jumps or unreasonably large distances between consecutive waypoints. Additionally, the error-checking routines include a timestamp synchronization to verify that the source timestamp associated with the route string aligns with the temporal data of waypoints and air traffic configurations.

The method 300 may further include executing additional error-checking routines using proprietary logic to provide for the continuity and accuracy of the decoded flight route. In at least one embodiment, the processor 112, when executing the route analysis module 206, applies a “next-to-next” waypoint validation methodology. The feature includes evaluating not only the next immediate waypoint in the decoded route string but also the subsequent waypoint, forming a predictive breadcrumb trail. The feature is configured to inhibit recursive pathing, such as unintentional backward movements in the route trajectory. The feature provides that the planned route reflects a forward-moving, non-repetitive sequence of waypoints. The method 300 may also address waypoint name duplications in the global registry. In at least one embodiment, a waypoint identifier may exist with distinct geographic coordinates in different regions (e.g., a waypoint named “TUN” may exist in both Tunisia and China). To resolve such ambiguity, the processor 112 applies geographic distance filters using Python-based distance calculation functions. The method is configured to eliminate the outlier by selecting the waypoint closest to the previous validated coordinate in the route sequence. Additionally, the data validation module 204 may associate the selected waypoint with the corresponding Flight Information Region (FIR), to provide spatial consistency and accurate alignment within the correct jurisdiction. The association can be stored in the external data storage 104 as part of the waypoint-to-FIR relational structure.

At 304, the method 300 includes generating a plan route line providing a plan route geographic representation of latitude and longitude values based on the plan route geographical coordinates. The transformation includes resolving the waypoint into geographic coordinates, including latitude and longitude values, to create a continuous geographic line. The plan route data and the plan route line include geographic coordinates representing the waypoints along the planned flight path, origin and destination countries derived from the initial and terminal waypoints, entry and exit points for the Flight Information Region (FIR) intersected along the planned route, distances traveled within the FIR, and associated metadata such as the flight reference number, source timestamp, and route-specific parameters. The plan route data further includes structured geographic representations, such as line strings, and latitude and longitude of the waypoint.

At 306, the method 300 includes generating flown route data by extracting sequential waypoint data from a flown navigation data, wherein the flown route data includes flown route geographic coordinates.

The waypoint data includes sequentially recorded geographic coordinates corresponding to the aircraft's actual path. The method 300 includes processing the waypoint data by sorting the waypoints in order of sequence. The sequenced waypoints in the flown route data provide the chronological progression of the aircraft through airspace. The flown route data includes sequentially recorded geographic coordinates representing the actual path of the aircraft, arranged into a geographic representation as the flown route line. The flown route data further includes chronological waypoint sequences, latitude and longitude points, and associated metadata such as timestamps.

At 308, the method 300 includes generating a flown route line providing a flown route geographic representation of the flown route geographic coordinates. The flown route line represents a sequenced waypoint data in a continuous geographic representation. The flown route line provides a geospatial representation of the aircraft's actual trajectory, enabling accurate spatial analysis and airspace cost determinations.

The method 300 may further include applying error-checking routines during the construction of the flown route line. The error-checking routines may include verifying the geographic continuity of the sequential waypoints to provide that the recorded flight path forms a logical and contiguous line without abrupt discontinuities. The error-checking routines may also include cross-referencing the waypoint data against a predefined database of valid waypoints to validate that the waypoint exists and is accurately recorded.

At 310, the method 300 includes determining a plan route intersection object and a flown route intersection object. The plan route intersection object includes a plurality of plan route intersection coordinates at the points where a plurality of FIR boundaries intersects with the plan route line. The flown route intersection object includes a plurality of flown route intersection coordinates at the points where the plurality of FIR boundaries intersects with the flown route line.

The method 300 includes determining intersections between the planned and flown route lines and predefined geospatial boundaries, such as Flight Information Regions (FIRs). The planned route line and flown route line are generated from navigation data, to identify entry and exit points within the FIR. The intersection points are analyzed to determine calculation metrics (also referred to as calculation data), including the distance flown within the FIR and the corresponding countries.

The planned route intersection object includes the plan route line. The plan route line may refer to a geographic representation stored as a database line string e.g., PostgreSQL-based line string. The planned route intersection object may further include a plurality of FIRs traversed by the planned route, the flight reference number, the Tail #(a tail could be characterized by a unique MTOW weight), aircraft type, the source timestamp, and the origin and destination countries.

The generation of the planned route intersection object includes processing the plan route data and the plan route line. The method 300 includes identifying the intersection points with FIR boundaries against the geographic representation of the planned route line. The intersection points or coordinates are calculated by comparing the geographic coordinates of the plan route line with FIR boundary data. The method 300 determines the FIRs traversed by identifying the FIR boundaries intersected by the planned route line. The flight reference number, the aircraft type, and the source timestamp included in the planned route intersection object can be retrieved from the plan route data. The origin and destination countries are determined by analyzing the geographic coordinates of the initial and terminal waypoints in the plan route line and cross-referencing the geographic coordinates with country-specific data. The origin and destination countries can also be determined by departure and arrival airports.

The flown route intersection object includes the flown route line as a geographic representation of the actual path flown. The flown route intersection object further includes the FIRs traversed, the flight reference number, the type of aircraft, and the source timestamp. The flown route intersection object may not use additional alignment, as the sequence of waypoints inherently reflects the flown path. Unlike the planned route intersection object, the flown route intersection object may not need additional alignment because the sequential waypoints in the flown route data inherently represent the chronological progression of the flight path.

The source timestamp includes the temporal data associated with a flight, representing the specific time at which the flight-related information, such as planned or flown route data, is recorded or applies.

The method 300 includes generating the flown route intersection object by analyzing the flown route data and the flown route line. The method 300 provides for calculating intersection points by comparing the geographic representation of the flown route line with FIR boundaries. The FIRs traversed are identified by determining where the flown route line intersects the geospatial polygons defining the FIR. The flight reference number, the type of aircraft, and the source timestamp included in the flown route intersection object are retrieved from the flown route data as part of the flown route intersection object.

In at least one embodiment, the method 300 includes executing the intersection calculation process by applying geometric line intersection functions to identify points where the planned and flown route lines intersect with FIR boundaries. For the planned route, the intersection points are computed between the geographic coordinates of the planned route line and the boundaries of the planned FIRs. Similarly, the intersection points for the flown route are computed by comparing the geographic coordinates of the flown route line with the flown FIRs.

In at least one embodiment, the method 300 includes executing a sorting process to the intersection points for sequential alignment along the respective route in the plan route data. The lengths of line segments between consecutive intersection points can be calculated using geospatial computations, such as lineLength functions applied to the geographic coordinates of the route line. Based on the calculations, the method 300 orders the points for accurate alignment along the planned route. If the segment lengths are equal, the existing order of the points is maintained.

The method 300 iterates through intersection result(s) in the dataset to process and extract relevant attributes for generating structured intersection objects. The planned route intersection object and the flown route intersection object include data values such as the FIR associated with the intersection, FIR tag data indicating the airspace over which the flight passes, the FIR name, the corresponding country, and the flight reference number. The planned route intersection object and the flown route intersection object may further include data values such as one or more of the aircraft's maximum takeoff weight (MTOW), wingspan, aircraft model, the common-reference GMT date and time of the intersection, and distances traveled within the FIR in both kilometers and nautical miles and any other unit required by the function provided in the machine-executable instructions. The origin and destination points of the flight, and the sequence order of intersections along the respective routes are determined. The FIR name and the corresponding country can be determined by matching the intersection points with geospatial data that includes FIR boundary definitions and associated metadata. The distances traveled within the FIR are calculated using geospatial computations applied to the geographic coordinates of the intersection points. The origin and destination points are derived from the initial and terminal waypoints in the respective route data. The sequence order can be established using the chronological arrangement of waypoints in the flown and planned route lines.

The planned route intersection object includes origin and destination country data, which can be processed for applying specific billing formulas that depend on national boundaries. In contrast, the flown route intersection object is aligned based on the ordered waypoint data and represents the actual trajectory of the aircraft. In at least one embodiment, the method 300 identifies departure and arrival airports by retrieving ICAO and/or IATA codes and corresponding geographic coordinates from a memory.

In at least one embodiment, the method 300 includes generating data points associated with geographic and spatial coordinates, accounting for vertical transitions as the aircraft climbs or descends through altitude-defined airspace classifications. For example, a flight from Toronto to San José, Costa Rica may incur enroute charges within the Central American FIR while flying over Costa Rica, with the charges paid to COCESNA as the designated billing authority for altitudes above 14,500 feet. Below 14,500 feet, the charges are classified as Terminal Charges and are levied by the Civil Aviation Authority (CAA) of Costa Rica, which issues a separate invoice to the airline as a Terminal Landing Charge. The method includes generating start and end coordinates for each segment traversed in both the planned route line and the flown route line, capturing both lateral and vertical route characteristics. The data points are represented as geospatial points, referred to as the start point and end point of the flight segment, respectively.

In at least one embodiment, the method 300 includes generating an intersection result by integrating the planned route intersection object and the flown route intersection object. The intersection result may be structured as an array of objects representing a single intersection event for a specific flight. The intersection event(s) include information such as the geographic coordinates of the entry and exit points within a specific Flight Information Region (FIR), the associated FIR name and code, and the governing country of the FIR. Additional attributes include the flight reference number, the sequence order of the intersection within the flight's path, and metrics such as the distance traveled within the FIR in nautical miles and kilometers, as well as the elapsed time in minutes. The method 300 provides for associating aircraft-specific details, including maximum takeoff weight (MTOW) and wingspan, to intersection event(s) for supporting weight-dependent and region-specific charge calculations.

At 312, the method 300 includes selecting a country billing function based on the plurality of FIR boundaries intersected by either a plan route intersection object or flown route intersection object. The plurality of FIR boundaries may correspond to a corresponding country billing function.

At 314, the method 300 includes generating a charge value data by applying the selected country billing function on data values in an associated intersection object. The selected country billing function can be associated to either a plan route intersection object and a flown route intersection object. The data values may include one or more of flight reference data, aircraft type data, FIR code, distance covered in a corresponding FIR, time elapsed in the corresponding FIR. In at least one embodiment, the instructions executed by processor 112 are further configured to detect multiple entries and exits into the same FIR. The method tracks crossing of the FIR boundary and evaluates the corresponding segment distances. The processor identifies the final exit point based on the chronological sequence of route data, enabling it to classify the event as an overflight. The instructions provide for aggregating the distances of each entry-exit pair into a totalized overflight segment distance, which is then passed to the charge calculation module 208.

An intersection object includes FIR-specific properties such as one or more of the FIR code, country, full FIR name, distance covered in nautical miles, and the elapsed time spent within the FIR.

The method 300 determines whether to select the planned route or the flown route data for charge calculations by referencing predefined country-specific billing rules. The billing rules can be stored in a database. The database includes country-specific configurations that identify whether charges for an FIR are based on planned route data or flown route data. For example, the method 300 may include correlating FIR tags from the intersection objects with entries in the database to identify billing formulas, such as applying the Eurocontrol formula for European FIRs or other country-specific formulas for non-European FIRs.

The method 300 includes retrieving country specific billing functions from a repository of country specific billing functions stored in the database. The function(s) may include variables and parameters such as distance, elapsed time, maximum takeoff weight (MTOW), and unit rates specific to the corresponding FIR's country. Upon matching the FIR tag to a function, the method provides for selecting the appropriate billing functions. For example, when a European FIR is identified, the method 300 applies the Eurocontrol function. For non-European FIRs, the method performs a lookup to identify and retrieve the relevant function from the database.

In at least one embodiment, the method 300 provides for dynamically selecting either the planned route intersection object or the flown route intersection object based on predefined country-specific billing rules. Once the appropriate object is identified, the method 300 includes retrieving data values such as the FIR code, country, full FIR name, distance covered, elapsed time within the FIR, and aircraft-specific details including maximum takeoff weight (MTOW) and wingspan from the selected intersection object.

The charge value data includes the FIR code, FIR name, associated country, distance traveled, elapsed time in minutes, the calculated airspace usage charge, and the corresponding currency details. Additional data points include the MTOW, wingspan, and geospatial details such as entry and exit points for the FIR. The charge value data may also include the flight reference number, which links the computed charges to the specific flight, and timestamp details to ensure traceability and temporal alignment of rates.

In at least one embodiment, once the selection between the planned or flown route data is made, the method 300 calculates airspace charges using the data from the selected intersection object. The method 300 computes the charge value data by applying the retrieved country-specific function to variables extracted from the selected intersection object and supplemental aircraft or flight-specific data. The determination includes processing metrics such as distance traveled within the FIR, elapsed time within the FIR, and MTOW of the aircraft. For example, the distance in nautical miles is multiplied by a unit rate specific to the FIR and applies a coefficient based on the MTOW to derive the total charge for the FIR.

In at least one embodiment, the method 300 utilizes multiple data variables in the formula application process. The FIR properties extracted from the intersection object may include one or more of the FIR code, country, full FIR name, distance covered in nautical miles, and elapsed time within the FIR in minutes. Aircraft-specific properties retrieved from the navigation data may include the MTOW for weight-dependent function, and the aircraft model, which provides additional specifications such as wingspan for applicable functions. Flight-specific properties include the flight reference number, which identifies the flight, and the timestamp of the flight. The timestamp ensures that valid unit rates corresponding to the applicable date range are applied.

The method 300 may further include storing calculated charge values in the FIR Calculated Information Table. The Calculated Information Table may include the FIR code, country, elapsed time, distance covered, and computed charge values for the FIR traversed. Additionally, the method 300 associates the charge values with the flight reference number and other relevant attributes for traceability and reporting purposes. The calculated charges are then integrated into downstream processes for billing, reporting, and regulatory compliance.

The geospatial computations may include measuring the geodesic distance between the entry and exit points of the FIR, derived from geographic data in the intersection objects. The method 300 may further associate the calculated cost with its corresponding flight reference number, FIR properties (e.g., country, name, and traversal order), and optionally additional data, including one or more of waypoints, elapsed time, and currency conversion details. The table may also include aircraft attributes, such as MTOW and/or wingspan, which may be used for certain billing calculations.

For non-European FIRs, the method 300 includes executing the appropriate country-specific function identified based on the country attribute of the intersection object. The function(s) is configured to handle country-specific billing requirements, such as weight and distance adjustments, fixed overflight charges, and domestic reductions. For example, the country's function uses parameters such as weight, distance, origin and destination countries, and aircraft specifications. The method includes applying a domestic reduction factor for flights that begin and end within that country. The international flights originating or destined to that country can be charged based on specific landing rates.

In at least one embodiment, the method 300 includes generating input variables required for the function application by organizing data from multiple objects. The input variables can be based either on planned route intersection object or flown route intersection object based on the function's requirement. The first object may include universal parameters such as time, total distance traveled in kilometers, distance in nautical miles, and MTOW. The second object may include country-specific attributes such as origin and destination FIR tags, entry and exit points, and aircraft model data.

The Calculated Information Table provides a centralized repository for computed charges, associated metrics, and supporting attributes. The method 300 may provide that the data is displayed meaningfully by associating the calculated charges with visual and textual attributes such as the sequence order of FIR traversal, geographic data for entry and exit points, and currency conversion details.

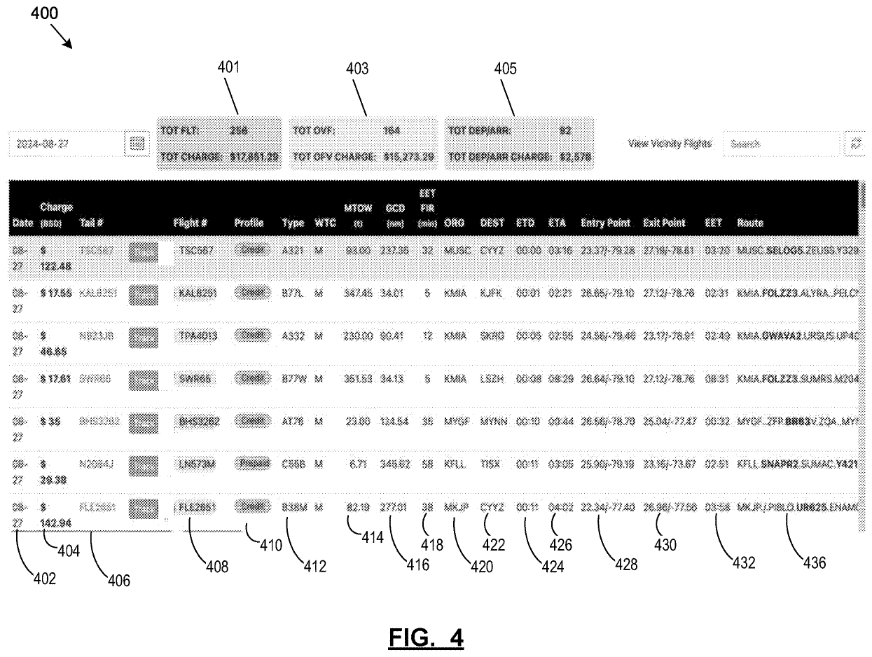

Reference is now made to FIG. 4, which shows a screen view of an interface 400, i.e., a Graphical User Interface (GUI), connected to an ANSP cost determination system, according to an example embodiment. For the purposes of illustration, the interface can be implemented by the host processor 112 of the server 102 of FIG. 1. However, in alternative embodiments, a different processor may be additionally used or used instead to generate and perform the function as associated with the interface 500. However, for ease of illustration, the functions performed that are associated with displaying the data shown in interface 400 will be described as being performed by processor 112.

The interface 400 provides an integrated screen view within the ANSP cost determination system, providing real-time visual access to flights related to the ANSP including various information such as airspace usage, airport usage and cost information. The screen view enables tracking of flights and the calculation of associated airspace and terminal charges, displayed in a user-friendly format for system operators. The interface leverages backend integrations with various modules, including geospatial data algorithms, billing algorithms, and external data sources, to provide accurate and timely cost and flight data.

The total flight count and total charge section 401 provides aggregated data on the number of flights processed within a selected period and the corresponding cumulative charge for these flights. It should be noted that a section of the interface 400 may also be referred to as a field or may contain several fields (e.g., one field for each flight or several fields when several data items are being displayed). The data displayed in the section 401 is generated from flight records stored within the system's cost data storage. The flight's associated charges are calculated based on route-specific billing formulas stored in or accessed by the charge calculation module 208. The host processor 112 retrieves records of flight paths, airspace traversals, and terminal services to compute and aggregate the charges. The aggregates charges present a total value that reflects real-time billing and cost adjustments as new flights are logged or charges updated.

The total overflight count and total overflight charge section 403 provides a breakdown of flights that incurred overflight fees by crossing various airspaces and the cumulative cost associated with the flights. The total overflight charge is calculated based on great-circle distances traversed within Flight Information Regions (FIRs) applied on the selected flown path or the planned path by a given airplane. The rates are applied according to country-specific billing regulations. The charge calculation module 208 includes software instructions to configure the host processor to dynamically compute charges for a given overflight by analyzing entry and exit points within the FIR, applying geospatial calculations to measure distances in nautical miles (nm) along the great-circle path. The overflight fees are then aggregated for relevant flights to display a comprehensive view of the overflight-related revenue. The relevant flights can be defined with respect to a set of planes operated by a given airline operator or the planes that fly through a given airspace and/or use a given airport's services.

In at least one embodiment, a system and method are provided for a graphical user interface (GUI) dashboard configured to present a real-time financial overview of an air navigation service provider's (ANSP's) daily revenue. The interface is generated by the processor 112 and presented through the Operations Management System (OMS) dashboard, which operates in either ANSP or airline operator mode, depending on the user role. The dashboard includes a cash till summary panel, displaying total revenue earned within a defined time window, such as the current day. The revenue summary is segmented by charging formula types, including Overflight Charges and Landing/Takeoff Charges, with each value derived from data processed through the charge calculation module 208. Beneath the summary, a column-based flight data table is presented. Each row corresponds to a flight instance and includes multiple flight-specific attributes retrieved from memory 114 or external storage 104, including Flight Number, Tail Number, Origin and Destination Airports, Flight Date, Aircraft Type, and Maximum Takeoff Weight (MTOW). The processor further displays algorithmically calculated flight distance, flight duration, entry and exit coordinates and timestamps for the chargeable airspace, and the filed route string, decoded via the route analysis module 206. The dashboard includes advanced filtering tools that allow users to dynamically refine displayed results based on parameters such as Date, MTOW, Airline, and Great Circle Distance (GCD). Additionally, a search field enables the user to retrieve a specific flight record using keyword or reference input. This combination of real-time data visualization, algorithmic charge calculation, and interactive search functionality improves operational transparency, supports financial analysis, and facilitates faster billing verification for ANSP stakeholders.

The total departures and arrivals section 405 displays the count and accumulated charges for flights involving takeoffs and landings within one or more specified airports. The system processes data from the airport management systems to track the flights'departure and arrival records and determines terminal fees/charges accordingly. The charge calculation module 208 includes software instructions for cross-referencing the data with terminal service rates and updates the departure and arrival charges based on airport-specific tariffs. The section 405 provides for the accurate computation of terminal charges, especially for airports with variable fees for landing, parking, or ground services. A charge is calculated by retrieving specific billing formulas stored within a database in the system and applying them to the departure or arrival event, which is then updated on the interface 400.

The interface 400 further includes a date of charge section 402, which denotes the specific billing period applicable to the calculated charges. The date data can be automatically retrieved and updated by the system's scheduling and billing functions, which are configured to process charges based on predefined billing cycles (e.g., monthly, quarterly, or real-time). The host processor 112 provides synchronization with external billing databases to provide consistent and accurate timestamping on all charges.

The charge in local currency section 404 displays charges in different currencies, enabling the system 100 to comply with various national billing requirements. A flight processed within the system 100 is identified by a unique flight number 408, which serves as an identifier across the interface 400 and backend of the system 100. The flight number can be retrieved from real-time flight tracking data, allowing operators to link the displayed cost calculation to the specific flight. The flight number 408 provides for maintaining traceability within the system 100, ensuring that charges, distances, and times are correctly associated with the respective flight number. The flight number can be stored in the cost data storage.

The profile section 410 indicates whether the flight is billed on a credit or prepaid basis. The profile section 410 can be processed by the system's payment processing module, which references stored customer profiles to determine the applicable billing structure. Backend operations retrieve these profiles from customer databases, categorizing them as credit or prepaid.

Additionally, the aircraft type section 412 displays the specific model of the aircraft associated with a given flight. The section 412 is populated from data retrieved from flight tracking or aircraft databases. The aircraft type may be used for calculating charges related to the aircraft's characteristics. The host processor 112 processes aircraft type information as a parameter for the charge calculation module 208, which may apply aircraft-specific rates or coefficients based on the aircraft type's impact on airspace use.

The maximum takeoff weight (MTOW) field 414 of a given aircraft is a parameter for cost determination in certain regulatory environments where charges are scaled according to aircraft weight. The MTOW data can be either stored in the system's internal database in memory 114 or sourced from external aircraft registries. The processor 112, when executing the software instruction of the charge calculation module 208, accesses the MTOW value to apply weight-based rates or adjust fees according to billing regulations specific to the FIR or airport.

The great-circle distance (GCD) field 416 between the originating and destination airports is computed and displayed in nautical miles, providing a basis for calculating overflight charges. The host processor 112 can calculate the GCD using the Haversine formula or colatitude method (e.g., as required by Eurocontrol), as appropriate, to account for the Earth's curvature, to provide precision over long distances. The calculated distance is processed for applying overflight rates based on distance traversed within the FIR and is integrated with billing calculations to apply rates per nautical mile, in synchronization with country-specific ANSP billing regulations.

The Estimated Elapsed Time within the FIR (EET FIR) field 418, displayed in minutes, provides the anticipated flight time within the Flight Information Region (FIR) along the aircraft's route. The host processor 112 calculates the EET 418 by processing either or both the planned and actual entry and exit coordinates within the FIR and processing the data through geospatial algorithms that estimate elapsed time based on speed, altitude, and path curvature.

The originating airport field 420, displayed with IATA or ICAO identifiers, indicates the airport where the flight commenced and serves as a basis for departure-related charges. Data for the originating airport is retrieved from integrated flight management systems and external databases, providing that airport-specific departure fees are calculated based on predefined rates stored within the cost data storage.

The destination airport field 422 displays the IATA or ICAO code for the airport where the flight is scheduled to land, providing a reference point for arrival-based charges. Integrated with airport management and arrival control systems, the host processor 112 uses the destination airport code to calculate terminal and arrival charges as applicable based on stored rates and service utilization data retrieved from external sources. The destination airport code also enables tracking for final billing assessments.

The Estimated Time of Departure (ETD) field 424 shows the expected departure time for the aircraft. The ETD field 424 can be sourced from flight scheduling systems in synchronization with departure control data. The host processor 112 processes a given ETD value to manage time-sensitive billing functions, particularly when delays or early departures may alter applicable costs.

The Estimated Time of Arrival (ETA) field 426 displays the anticipated arrival time for the aircraft, calculated based on current flight speed and path data. Synchronized with real-time flight tracking updates, values in the ETA field 426 provide a reference for calculating charges linked to scheduled arrival timing. The entry point coordinates section 428 displays the geographic coordinates where the aircraft enters the FIR, providing for calculating charges linked to airspace entry. The entry point coordinates can be determined based on planned or flown route data decoded when executing the software instructions of the route analysis module 206 and cross-verified with real-time flight data.

The Estimated Time of Departure (ETD) field 424 is configured to display the expected departure time for a flight. The value is retrieved by the processor 112 from integrated flight scheduling systems, and reflects either the Scheduled Time of Departure (STD) or an updated estimated time based on operational delays or adjustments. In conventional aviation systems, the STD is the reference time shown on passenger tickets, while the ETD reflects deviations from the baseline schedule. To improve efficiency, the system consolidates both STD and ETD values into a single ETD field. The ETD 424 value serves as the temporal anchor for time-sensitive computations across the system. In at least one embodiment, the charge calculation module 208 uses the ETD as the basis for estimating downstream FIR entry times along the planned or flown route. The feature is provided by adding segment-specific flight duration, calculated from the route analysis module 206, to the ETD. For example, a flight departing New York at 13:45 local time may be scheduled to enter the Bahamas FIR on the following calendar day, when converted to Coordinated Universal Time (GMT). The system adds the segment flight time to the ETD to determine the FIR entry timestamp, which is critical for determining the applicable unit rate, billing date, and currency exchange rate, where required.

The exit point coordinates section 430 provide the geographic points at which the aircraft exits an FIR, forming the endpoint for calculating FIR-specific charges. By determining the exact location of the FIR exit, the host processor 112 can precisely calculate the distance traveled within the FIR and apply the correct billing rate based on country-specific charge requirements.

The Estimated Elapsed Time (EET) field 432 for the entire flight route represents the total anticipated flight duration, aggregating EETs for the FIR along the route to provide a comprehensive overview. The total EET data can be generated when executing software instructions of the charge calculation module 208 and can be stored in memory 114 or external storage along with or linked to/associated with the flight path data. The host processor 112 can process the EET for route-wide billing applications, providing ANSPs and airlines with a complete cost estimation based on total time across airspaces traversed.

In at least one embodiment, the system is configured to consolidate multiple charges within a single FIR and across multiple charge types within a given State. For example, a flight departing from Toronto enroute to Spain may incur airport charges payable to the Greater Toronto Airports Authority (GTAA), as well as additional charges to NavCanada for de-icing, communication services, and the Terminal Maneuvering Area (TMA) charge. As the flight progresses, the flight may be subject to multiple enroute charges over regions such as Toronto, Montreal, Moncton, and Gander Domestic FIRs, each calculated using the domestic enroute billing formula. Upon entering Gander Oceanic airspace, additional charges may apply, including ADS-B fees, Datalink communication charges, and oceanic enroute service fees.

In at least one embodiment, the system is configured to recognize and apply bi-lateral trade exemptions. For instance, a JetBlue flight from Boston to Seattle may enter the Toronto FIR, but due to an existing bi-lateral agreement between the United States and Canada, the system suppresses associated FIR charges. The processor 112, when executing the charge calculation module 208, references a stored database of bi-lateral treaties and cross-border billing exclusions to determine when such exemptions apply.

The route string field 436 provides a sequential list of waypoints that defines the planned or actual flight path of a given airplane. The route string field 436 can be processed when executing software instructions of the route analysis module 206. The route string can be converted into latitude and longitude coordinates for the waypoint, which are then sequentially connected to form a linestring representing the flight path. The route string supports comprehensive billing calculations, as it enables the host processor 112 to analyze the FIR traversal and calculate distances, times, and entry/exit points along the route.

In at least one embodiment, the system and method provide for the integration of geospatial detection tools within the graphical user interface (GUI) dashboard, enabling identification of flights that approach but do not enter an air navigation service provider's (ANSP) charging airspace. This feature is referred to as “VICINITY FLIGHTS.” The tools can be executed by the processor 112, in conjunction with the route analysis module 206, and operates by applying a configurable proximity threshold. The threshold defines a buffer zone surrounding the FIR boundary, by default set to 12 nautical miles, and adjustable based on operational requirements. When enabled, the system continuously monitors planned or flown routes using geospatial line intersection algorithms, detecting aircraft that come within the threshold distance but do not intersect the FIR polygon stored in memory 114 or external data storage 104. The dashboard then generates a list of such vicinity flights, displaying operational details such as Flight Number, Tail Number, Origin and Destination airports, Aircraft Type, Maximum Takeoff Weight (MTOW), total flight distance, and filed route information. Further, the system supports proactive customer engagement by highlighting potential benefits to the operator, such as shorter routing, fuel efficiency, lower CO₂ emissions, and reduced time enroute. The data insights can be used by ANSPs to initiate discussions with nearby carriers and promote voluntary routing through the ANSP's airspace, offering transparency around the marginal cost advantages of entry.

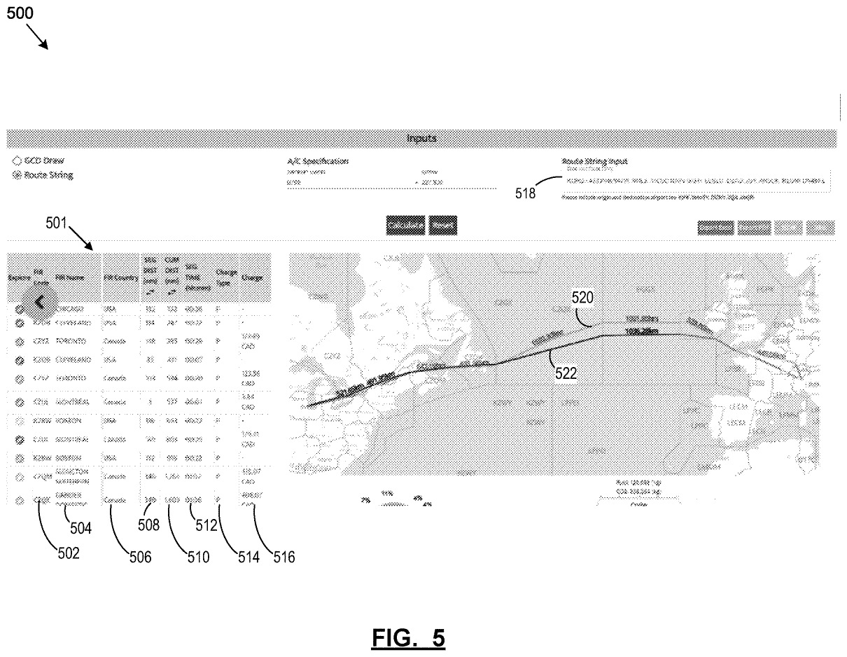

Reference is now made to FIG. 5, which shows a screen view of another interface 500 provided by an ANSP cost determination system, according to an example embodiment. The interface 500 can be implemented by the host processor 112 of the server 102 of FIG. 1. However, in alternative embodiments, a different processor may be additionally used or used instead to generate and perform the function as associated with the interface 500. However, for ease of illustration, the functions performed that are associated with displaying the data shown in interface 500 will be described as being performed by processor 112.

The interface 500 presents a table 501 that is generated for the ANSP cost determination system, providing detailed segment-by-segment information for flights traversing different Flight Information Regions (FIRs). The table 501 integrates real-time data from the backend modules responsible for geospatial processing and billing calculations, providing an overview of flight segments, associated distances, times, and charges.

The FIR code section 502 includes fields with FIR codes that displays the unique identifiers for the FIR traversed by a given airplane during a given flight. The processor 112 automatically retrieves the FIR code from geospatial databases, where a code is linked to specific geographic coordinates.

The FIR name section 504 includes fields with FIR names that provide the full name of the FIR corresponding to the FIR codes in column/section 502. The processor 112 can retrieve the FIR names from external airspace management systems or internal data storage, providing that operators can associate the FIR code with its geographical location.

The FIR country section 506 includes fields for the country corresponding to the FIR code. The FIR country data is used to apply country-specific billing regulations stored in the system's charge calculation module 208 or accessed from another database during processor operation. Depending on the country traversed, the processor 112 retrieves the relevant billing formulas and applies them to calculate navigation charges for that specific airspace segment.

The segment distance section 508 includes fields that display the distance in nautical miles (nm) flown within the FIR segment. The processor 112 calculates the segment distances based on great-circle distance formulas, such as the Haversine formula, or the Colatitude method accounting for the curvature of the Earth.

The cumulative distance section 510 includes fields that show the aggregate distances flown across multiple FIRs, providing a running total of the distance traveled from the airplane's point of origin for the flight. The cumulative distance data can be calculated by the system in real-time, continuously updating as additional FIRs are traversed.

The segment time section 512 includes fields that show the estimated elapsed time (EET) for the FIR segment in hours and minutes (hh:mm). The EET data is computed based on the flight's speed and the segment distance. The processor 112 can retrieve the real-time flight speed data from onboard tracking systems or external data sources.

The charge type section 514 includes fields that indicate whether the flight is billed on a prepaid (P) or credit (C) or card-on-file (CoF) basis. The processor 112 can retrieve the charge type data from customer profiles stored in the payment processing module.

The charge value section 516 includes fields that display the total charge for the FIR segment in the local currency. The charge can be calculated by the processor 112 based on the distance traveled within the FIR, the time spent in the airspace, and the applicable billing regulations.

The route string section 518 includes fields that show the flight route input. The processor 112 can decode the route string, transforming it into geographic coordinates that are used to calculate overflight charges.

The interface 500 also provides a visual representation of both the planned route 522 and the flown route 520 (for the actual flight path that is flown). The flown route 520, may be displayed in a distinct color, and can be shown along with the planned route 522, allowing users to compare the two routes and assess any deviations. The processor 112 can retrieve real-time flight data from onboard tracking systems and compare it with the planned route.

The above interfaces are just a few examples of the outputs of the disclosed systems, devices, and methods. Any other implementation can be provided, and it is not limited to the specific implementation described. Further, the technical processes in the background, as detailed in other parts of this document, should be read in coherence while noting the technical improvements and efficiency achieved in the disclosed systems, devices, and methods.

Reference is now made to FIG. 6, which shows a flowchart of an example method 600 for determining airspace and airport services cost determination in an efficient manner, according to an example embodiment. For ease of illustration, the method 600 is described as being performed by the system 100 that has a system architecture described as follows. For example, the server 102 can implement on a parallel worker process architecture for performing the method 600 to improve efficiency to allow for real-time or near real-time operation while handling large volumes of data such as when tracking several airplanes at the same time and performing the tracking and analysis for many user terminals 108 at the same time. The architecture includes an in-memory database such as a Redis in-memory database, for example, and daemon-based multiple worker processes for real-time processing of flight reference numbers received in an external database. The in-memory database (e.g., Redis) may be used to manage real-time flight reference queues (by using an in-memory queue), and a graph (e.g., RedisGraph, FalkorDB, Neo4j) or relational database (e.g., PostgreSQL) may be used to store airspace, navigation, and billing-related data for handling of flight reference processing that is received from remote devices at, for example, the external systems 120 and 130 and the airplanes 110 and optionally the user terminals 108 in case a user has to correct any data used by the system 100. While the description below may refer to one type of in memory database and one type of relational database it should be noted that other types of in memory and relational databases may be used, some examples of which are provided herein.

The relational database may be described as a flight database for the description of FIG. 6. Furthermore, for ease of description, the PostgreSQL relational database and Redis in-memory database will be used, but it should be understood that other databases and worker processes, examples of which are provided herein, may be used that provide similar functions and similar advantages of improved efficiency, reduced computer resource usage and scalability. Accordingly, this system architecture addresses the inefficiencies of conventional batch processing, which relies on cron jobs and direct database operations. The integration of the described system architecture enables real-time data handling, asynchronous processing, improved scalability, and fault tolerance while maintaining consistency with the FIR Calculated Information Table, navigation databases, and charge calculation workflows stored, for example in memory 114 and external storage 104 of FIG. 1. These advantages of improved efficiency, reduced computer resource usage and scalability are beneficial due to the changing number of users 108 that may use the service provided by the server 102 as well as the number of airplane flights that are being processed which is dynamic and can become large in number.

In at least one embodiment, the system includes a backend daemon process configured to run as a standalone background service, isolated from the user-facing application layers. The daemon operates as an application-agnostic engine, responsible for high-speed, parallelized execution of flight plan-related calculations. The process is initialized once during system startup and loads the required operational database into in-memory storage, such as Redis or a similar high-performance, volatile data store. Once active, the daemon enters a continuous listening state, waiting for inbound calculation requests. Upon receiving a request, the daemon initiates a fork-based execution model, spawning a child process for each individual calculation task. A child process is assigned all required dependencies for the specific computation and operates in isolation. The feature architecture enables non-blocking, concurrent execution of a high volume of calculations, supporting real-time or near real-time performance. The forked child processes can be independent of the main process, providing fault tolerance and optimizing CPU core utilization. The system provides that any failure or delay in one child process does not affect other running tasks. The processor 112, when coordinating this execution flow, applies resource management rules to dynamically scale processing based on queue length or computational demand. The in-memory database remains active during this lifecycle and is only refreshed upon receiving an explicit update or versioning trigger. In certain implementations, the system may be deployed using container orchestration platforms, such as Kubernetes, to facilitate independent process scaling, lifecycle management, and fault recovery. The core daemon may remain decoupled from front-end interfaces and operates as a black-box component, executing flight plan calculations in isolated child processes with extremely low latency and high throughput.

At 602, the method 600 includes initializing system configurations. The initializing includes loading configurations for both the flight database (e.g., PostgreSQL database) and the in-memory queue (e.g., Redis in-memory queue), setting up logging mechanisms for debugging and monitoring, and initializing a Redis client for handling event notifications. The Redis in-memory database operates as a persistent message broker, facilitating communication between the PostgreSQL database, the worker processes, and the external systems such as external systems 120, 130 of FIG. 1, that provide flight tracking and charge-related data.

At 604, the method 600 establishes a connection to the PostgreSQL-based flight database, enabling the application to listen to a “new_flight” notification channel. The PostgreSQL database may be used to maintain flight data, including flight reference numbers, waypoints, planned routes, flown routes, FIR intersections, and charge calculation parameters. Whenever a new flight reference number is added to the PostgreSQL database, a trigger notification is sent. Upon receiving the notification, the method 600 extracts the flight reference and forwards it to the Redis in-memory queue. The feature enables immediate and real-time processing of flight information. The feature further enables that flight data stored in the FIR Calculated Information Table within memory 114 is consistently updated. The method 600 operates using this architecture such that, as new flight reference numbers are added, they are instantly detected and queued for further processing without relying on batch execution.

In at least one embodiment, the system includes a fork-based worker architecture, wherein each worker process is instantiated as a child process. The child processes can be placed by a daemon, which is initialized once during system startup and remains active in the background throughout the operational lifecycle. The daemon may not require significant system resources and maintains its state persistently, without restarting unless a database refresh or configuration update is required. A forked worker process operates independently and consumes a single flight reference from the Redis queue. Due to the isolation model, millions of such child processes can be supported concurrently, enabling massive parallelization without blocking or shared state dependencies. The processor 112 manages the child processes in a non-blocking execution loop, allowing each worker to retrieve the relevant flight data from the PostgreSQL database, process the required calculations, and update the FIR Calculated Information Table in memory 114.

At 606, the method 600 includes creating multiple worker processes to enable parallel and asynchronous handling of flight references. For example, in at least one embodiment, several lightweight worker processes are spawned, where the worker processes can concurrently monitor the Redis in-memory queue for new flight references. The number of worker processes can be scaled for handling a greater number of expected flight entries in the PostgreSQL flight database. As a flight reference is pushed to the Redis queue, the flight reference is picked up by an available worker process. The worker processes are configured to handle one flight reference at a time, providing isolated and efficient data handling. The worker processes maintain real-time synchronization with Redis, allowing concurrent processing of multiple flight references.

At 608, upon receiving a flight notification, the method 600 processes flight notifications by extracting the flight reference number from the PostgreSQL channel and pushing it to the Redis queue. The action serves as the trigger for the worker processes to begin their operations ensuring that updates are made to charge calculation workflows stored in memory, such as memory 114 of FIG. 1. The real-time nature of the notification and queueing mechanism provides that flight reference numbers are promptly processed as they arrive. The navigation data retrieved from the data storage 104 is updated as new flight records are processed.

At 610, the method 600 includes implementing a flight processing loop where worker processes retrieve (e.g., “listens for”) flight references from the Redis queue. A worker fetches a flight reference and executes database operations such as SQL operations, including insert, update, or delete queries, on the SQL database (e.g., PostgreSQL database) to process navigation and charge-related data. The SQL queries may include one or more of updating the FIR Calculated Information Table stored in memory 114 to log new FIR intersections and calculated charge data, adding new intersection objects and charge value data for a preset number of times. The flights, referencing waypoints, entry/exit points, and elapsed time within each FIR. Further, the SQL queries may include updating or inserting the cost determination records in the flight database to provide that airspace usage calculations reflect the latest geospatial and regulatory parameters retrieved from external systems 120, 130. In case of operational failures, the method 600 retries the failed operation for a preset number of times. The integration of retries provides fault tolerance and supports robust data processing workflows.

At 612, the method 600 performs an error handling mechanism to manage failures that persist after the retry attempts. If a worker process fails to process a flight reference even after multiple retries, the method 600 logs the failed flight reference to a file, such as “failed_Flights.txt.” This logged information can later be used for manual review and processing. The system feature provides automated tracking of failed records, allowing administrators to reprocess unbilled flights and missing charge calculations within the PostgreSQL-based billing system.

At 614, the method 600 includes a termination sequence to shut down worker processes and close active connections once a flight has been fully processed. For example, once an airplane has completed its flight or exited the charging airspace in question or has landed at an airport, as the case may be, the airplane no longer needs to be tracked and the worker process that was used to track the airplane flight and determine airspace usage and airport usage as well as to determine any corresponding charges can be terminated. The various usage and charge data related to this flight for the airplane can be saved to the flight database and a terminal signal may be used to end the worker process. For example, termination signals may be sent to worker processes via Redis to ensure that no active tasks are interrupted. Additionally, connections to Redis, the PostgreSQL database, and other services are closed to ensure a clean shutdown. In at least one embodiment, a worker process is dynamically driven by the type of executable instructions or algorithm associated with the requesting entity. For Air Navigation Service Providers (ANSPs), the worker executes logic that focuses on entry and exit points within the provider's charging airspace, calculating overflight and enroute charges specific to that FIR. For airlines, the worker process is configured to evaluate the entire flight route, from departure to arrival airport, encompassing all phases of flight and applying a broader set of billing formulas, including terminal charges, ground handling, and enroute fees across multiple FIRs. The algorithm selection is determined at runtime based on the user type and applied by the charge calculation module 208.

The integration of the parallel worker process architecture improves the scalability and efficiency of the airspace charge calculation system. The parallel processing capability allows simultaneous handling of multiple flights, enabling real-time calculations and inserts to the FIR Calculated Information Table and rapid generation of intersection objects and charge value data outputs.

By providing real-time Redis queueing alongside PostgreSQL-backed flight navigation and charge databases, the method 600 enables the system to process multiple flights concurrently, supporting near-instantaneous updates to the FIR Calculated Information Table. The architecture allows for the rapid generation of intersection objects, charge value data outputs, and airspace billing records in near real-time, enhancing the scalability and responsiveness of the system.

For example, the Redis component runs as a daemon process in the background. The Redis component can store key-value data in-memory for high-speed access, and uses a fork-based persistence mechanism, including RDB snapshots and replication to slave instances, ensuring fault tolerance and data durability. Redis can support millions of operations per second, serving both as a message broker for queued tasks and as a real-time data cache for ongoing computations.

The parallel execution model may be further supported by a structure inspired by Apache Spark, where a driver daemon manages distributed computational tasks. The driver forks independent executor processes across a compute cluster. These executors process flight data in parallel using constructs such as Resilient Distributed Datasets (RDDs), enabling high-volume route analysis and charge aggregation. The outputs from the executors are collected and returned to the main process for integration with the system's billing modules.

For asynchronous task handling, the system may adopt a Celery-style architecture, where a worker daemon listens for incoming tasks and forks multiple worker processes to handle each task independently. Task queueing is facilitated by message brokers such as Redis or other supported protocols. The feature allows the system to process millions of background tasks simultaneously, including flight plan decoding, route validation, and cost calculation.

On the server-side, the system can implement a request-handling model based on event-driven or threaded architectures similar to Nginx or Apache HTTP Server. A master daemon continuously listens for incoming requests from user terminals or external systems. Incoming requests are delegated to forked worker processes, allowing the system to serve large volumes of concurrent users without degradation in performance.

Variations to the described implementation of Redis and the parallel processing architecture can be applied without departing from the scope of the disclosure of the example embodiment in FIG. 6. For example, Redis may be substituted with other in-memory data stores or message queue systems, such as RabbitMQ or Apache Kafka, depending on system requirements for scalability, persistence, or fault tolerance. Similarly, the number of worker processes and their configurations can be adjusted to optimize processing based on hardware resources or the volume of incoming flight data. Alternative database systems or distributed computing frameworks may also be employed to improve compatibility or address specific limitations in the described implementation. For example, in alternative embodiments, other relational or NoSQL databases may be used instead of PostgreSQL for managing flight navigation and charge calculation data. For example, SQL-based databases such as those supporting structured queries with indexing may be used for data retrieval. NoSQL-based databases like document or column-store systems may be used for scalable storage for handling high-velocity flight data streams. Additionally, distributed and cloud-native databases may be used to provide high availability, automatic scaling, and optimized performance for real-time processing.

Reference is now made to FIG. 7, which shows a screen view display 700 of an example embodiment of a flight route decoding interface. The display 700 shows a structured flight route dataset displayed in a tabular format. The data may be rendered by the processor 112 executing instructions of the route analysis module 206, and is stored in memory 114 or external data storage 104. The figure illustrates multiple flight navigation parameters derived from a decoded route string, which may have originated from either planned flight data or recorded flown data.

The Waypoint column 710 includes a sequential list of navigation points representing the aircraft's geographic path. A waypoint entry includes a waypoint identifier, along with latitude and longitude coordinates, allowing for geospatial mapping and intersection determination. The waypoints are extracted from the route string and validated against a global waypoint registry, as described earlier, by the data validation module 204. The waypoints define the structure of the route and serve as input to FIR intersection calculations and charge estimation routines.

The Route Altitude column 712 identifies the planned cruising altitude at each waypoint. The altitude values, such as 8000 feet in this example, are used to determine compliance with FIR-specific vertical stratification. As described previously, the processor 112 utilizes this data when determining whether a flight segment qualifies as upper airspace traversal or falls under lower airspace rules for billing purposes.

The Wind Direction/Speed/Temperature/Deviation column 714 provides atmospheric parameters relevant for route-specific performance modeling. The column 714 include wind direction (e.g., 264°), wind speed (e.g., 20 knots), temperature (e.g., 10° C.), and the deviation from the standard temperature profile. These inputs may be used by the charge calculation module 208 when billing computations depend on time-in-air or performance-based coefficients.

The True Airspeed (TAS) column 716 shows the aircraft's speed relative to the surrounding air mass. This parameter is important for estimating time enroute and validating whether the expected velocity aligns with planned flight operations.

The Track/Wind Correction Angle (WCA) column 718 includes the compass heading the aircraft is intended to fly (Track), along with a wind correction angle (WCA) to compensate for crosswinds. The directional adjustments can be used to maintain an intended trajectory and are used by the route analysis module 206 to reconstruct the expected versus actual flown path.

The True Heading (TH) and Magnetic Heading (MH) column 720 and 722 shows the orientation of the aircraft relative to true north (TH) and magnetic north (MH). The headings are calculated by the processor 112 and provide key directional attributes used in building the geospatial linestrings used for route visualization and FIR intersection.

The Ground Speed (GS) column 724 represents the effective speed over ground, factoring in wind and other flight conditions. The value is calculated by comparing TAS with WCA and is relevant for estimating distance traveled within FIRs and for elapsed time (EET) computation. The Distance (Dist) column 726 reflects the segment distance in nautical miles between consecutive waypoints. This column is used by the processor 112 to accumulate distances flown within FIR boundaries and calculate FIR-specific usage metrics. These distances form the basis for charge calculations, as they are multiplied by per-nautical-mile rates defined in country-specific billing formulas. The Estimated Time En Route (ETE TO) and Actual Time En Route (ATE ATO) columns display the planned and actual travel time for each segment. These values may be computed in real-time using telemetry or derived from pre-flight planning data. The difference between ETE and ATE is useful for determining delays or variances, which may impact billing, particularly for time-based fee structures. The Fuel Estimated Flow Rate (EFR) and Actual Flow Rate (AFR) columns provide placeholders for fuel usage data, though the present example shows zero values. When populated, these fields may be used by the charge calculation module 208 to estimate performance-based charges or validate operational efficiency.

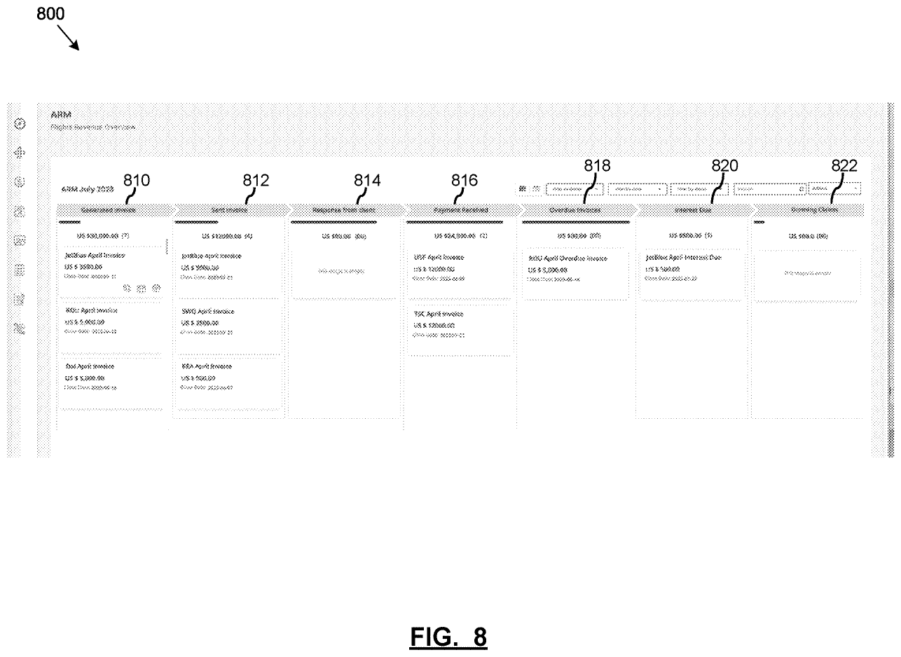

Reference is now made to FIG. 8, which shows a screen view display 800 of an example embodiment of an Account Relationship and Revenue Management (ARM) dashboard. The interface provides a structured visual workflow of the billing and payment lifecycle for airspace and terminal usage invoices, organized by stage. The display is generated by the ARM module, which retrieves operational billing data from memory 114 and synchronizes with invoice records stored in external data storage 104.

The Generated Invoice column 810 displays a list of invoices that have been prepared but not yet sent. An entry includes invoice metadata, such as invoice amount, associated airline, and close date. The column 810 is populated based on billing data generated by the charge calculation module 208, using FIR-specific distance, time, and weight-based metrics. The invoices are staged for manual or automated dispatch. The Sent Invoice column 812 displays invoices that have been formally issued to the airline or aircraft operator. The records reflect a transition in billing status and include close dates and unique invoice identifiers. The processor updates this column once a dispatch instruction is executed via email, API, or customer portal submission through the OMS dashboard operating. The Response from Client column 814 tracks responses received from recipients. In one embodiment, the column 810 is linked to the Claims module, enabling reconciliation or dispute initiation. It may remain empty if no action is recorded within the response window, as illustrated.

The Payment Received column 816 displays confirmed payments matched to issued invoices. The feature includes the amount, payee identifier, and payment date. Payment confirmation may be triggered by manual input or automated banking integration. The system logs this status and updates the payment lifecycle record for financial tracking and reporting.

The Overdue Invoices column 818 includes invoices that remain unpaid beyond their due date. The processor 112 monitors invoice age and flags entries exceeding predefined thresholds. This column supports escalation workflows and may trigger interest accrual processes. The Interest Due column 820 displays amounts added to overdue invoices as penalty interest. The processor applies interest computation logic stored in memory 114, referencing the original invoice terms and applicable billing policies. These entries are tracked separately for audit and compliance purposes. The Dunning Claims column 822 identifies escalation records initiated for unresolved invoices. The feat includes formal claims or follow-up actions filed through the ARM interface or customer-facing OMS portal. The status may trigger automated reminder notices or lead to manual enforcement steps depending on system configuration.

In at least one embodiment, the algorithms used may be configured to determine based on the entry/exit methodology to determine the type of charging formula to be used, e.g., i.e. Overflight, Terminal, Landing/Takeoff.

In at least one embodiment, an end-to-end system and related method are provided that integrates at least 3 main modules that work with flight plan and flow data where: a) a workflow is used to calculate each flight in a ‘black-box’ environment without exerting any strain in system resources in a way to run ‘millions’ of simultaneous forked child processes, b) a smart GUI is used that provides a baseline to raise accurate invoices, host them on a portal to follow the entire life-cycle of an invoice from generation to the real owner of each airline/flight and provide consolidated over a billing cycle (ARM) and c) a Front end customer interface that is hosted by the ANSP for ‘thousands’ of its customers. Such technology overcomes a current pain-point of having to send multiple invoices to a single user (for example, sending 10 invoices). Conventional systems use traditional postal mail to send paper invoices. The technology described herein provides a digital capability on the front-end GUI (OMS) with a secure logon and API. The front-end can also be used as a pre-pay for flights by smaller operators to ensure that all payments are accounted for (i.e. Credit for the big airlines, Card on File for the non-airline regular customers, and Pre-pay on the front facing web for the Itinerants).

While the description may refer to one processor performing various functions, it should be understood that in other embodiments more than one processor may be used for performing the functions more efficiently.

Numerous specific details are set forth herein in order to provide a thorough understanding of the example embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

1. A server for determining airspace and airport service usage including costs for a plurality of users for a plurality of airplane flights, the server comprising:
a communication interface for communicating with external systems for receiving airspace and airport service usage;
a memory that stores program instructions for determining airspace and airport service usage and costs; and
a processor that is operatively coupled to the communication interface and the memory, the processor, when executing the program instructions, being configured to:
access the external systems to receive, for a given airplane flight, a route string and flown navigation data;
generate plan route data by decoding the route string, wherein the plan route data includes plan route geographic coordinates generated by translating encoded waypoint data;
generate a plan route line providing a plan route geographic representation of latitude and longitude values based on the plan route geographical coordinates;
generate flown route data by extracting sequential waypoint data from a flown navigation data, wherein the flown route data includes flown route geographic coordinates;
generate a flown route line providing a flown route geographic representation of the flown route geographic coordinates;
determine a plan route intersection object and a flown route intersection object, wherein the plan route intersection object includes a plurality of plan route intersection coordinates at the points where a plurality of FIR boundaries intersect with the plan route line, and wherein the flown route intersection object includes a plurality of flown route intersection coordinates at the points where the plurality of FIR boundaries intersect with the flown route line; and
update a flight database to include flight reference data, aircraft type data, FIR code, distance covered in a corresponding FIR, and time elapsed in the corresponding FIR.

2. The server of claim 1, wherein the processor is further configured to:
select a country billing function based on the plurality of FIR boundaries intersected by either a plan route intersection object or flown route intersection object; and
determine a charge value data by applying a selected country billing function on data values in an associated intersection object, wherein the selected country billing function is associated to either the plan route intersection object or the flown route intersection object, and wherein the data values include flight reference data, aircraft type data, FIR code, distance covered in a corresponding FIR, and time elapsed in the corresponding FIR.

3. The server of claim 2, wherein the charge value data includes total distance traveled in nautical miles, total elapsed time, and calculated airspace usage charge.

4. The server of claim 1, wherein the processor is further configured to:
apply error-checking routines in the route string decoding process, wherein the error-checking routines include validating the encoded waypoint data by cross-referencing each waypoint in a given decoded route string with a predefined database.

5. The server of claim 1, wherein the plan route data and the plan route line include origin and destination countries derived from an initial waypoint and a terminal waypoint, a flight reference number, and a source timestamp; and wherein the plan route geographical coordinates represent a plurality of waypoints along the plan route line.

6. The server of claim 1, wherein the plan route line and the flown route line are geographic representations stored as PostgreSQL-based line strings.

7. The server of claim 1, wherein the planned route intersection object includes a plurality of FIRs traversed by the plan route line, a flight reference number, an aircraft type, a source timestamp, and origin and destination countries.

8. The server of claim 1, wherein the processor is further configured to retrieve the selected country specific billing function from a repository of country specific billing functions stored.

9. The server of claim 1, wherein the server comprises an in-memory database that uses an in-memory queue to manage real-time flight reference queues and a parallel worker process architecture for creating separate workers to determine usage and related calculations for each flight.

10. The server of claim 9, wherein the server comprises a relational database to receive a new flight reference number for tracking a new airplane flight and to generate a trigger notification which is used to extract the flight reference number and forward it to the in-memory queue to enable immediate and real-time processing of flight information for the new airplane flight being processed.

11. The server of claim 10, wherein upon determination of the new airplane being processed, a worker child process is started.

12. The server of claim 9, wherein several worker processes are used to concurrently monitor the in-memory queue for each new flight reference such that when the new flight reference is pushed to the in-memory queue, the new flight reference number is picked up by an available worker process.

13. The server of claim 11, wherein each worker process processes usage and related data for a separate airplane flight and maintain real-time synchronization with the in-memory database thereby providing concurrent processing of multiple flight references.

14. The server of claim 11, wherein additional worker processes are generated for scaling the server to track and determine usage and related data for a greater number of airplane flights.

15. The server of claim 9, wherein the relational database is used to store airspace, navigation, and billing-related data for handling of flight reference processing for a given flight reference number.

16. A method for determining airspace and airport services usage including costs for a plurality of users for a plurality of airplane flights, the method comprising:
providing a server having a communication interface, a processor and a memory storing program instructions for performing the method;
communicating with external systems, using the communication interface, to receive from a give airplane flight, a route string and flown navigation data;
generating, using the processor, a plan route data by decoding a route string, wherein the plan route data includes plan route geographic coordinates generated by translating encoded waypoint data;
generating, using the processor, a plan route line providing a plan route geographic representation of latitude and longitude values based on the plan route geographical coordinates;
generating, using the processor, a flown route data by extracting sequential waypoint data from a flown navigation data, wherein the flown route data includes flown route geographic coordinates;
generating, using the processor, a flown route line providing a flown route geographic representation of the flown route geographic coordinates;
determining, using the processor, a plan route intersection object and a flown route intersection object, wherein the plan route intersection object includes a plurality of plan route intersection coordinates at the points where a plurality of FIR boundaries intersect with the plan route line, and wherein the flown route intersection object includes a plurality of flown route intersection coordinates at the points where the plurality of FIR boundaries intersect with the flown route line; and
updating a flight database stored on the memory to include flight reference data, aircraft type data, FIR code, distance covered in a corresponding FIR, and time elapsed in the corresponding FIR.

17. The method of claim 16, wherein the method further comprises:
selecting, using the processor, a country billing function based on the plurality of FIR boundaries intersected by either a plan route intersection object or flown route intersection object; and
determining, using the processor, a charge value data by applying a selected country billing function on data values in an associated intersection object, wherein the selected country billing function is associated to either the plan route intersection object or the flown route intersection object, and wherein the data values include flight reference data, aircraft type data, FIR code, distance covered in a corresponding FIR, and time elapsed in the corresponding FIR.

18. The method of claim 17, wherein the charge value data includes total distance traveled in nautical miles, total elapsed time, and calculated airspace usage charge.

19. The method of claim 16, wherein the method further comprises:
applying error-checking routines in the route string decoding process, wherein the error-checking routines include validating the encoded waypoint data by cross-referencing each waypoint in a given decoded route string with a predefined database.

20. The method of claim 16, wherein: (a) the plan route data and the plan route line include origin and destination countries derived from an initial waypoint and a terminal waypoint, a flight reference number, and a source timestamp; and wherein the plan route geographical coordinates represent a plurality of waypoints along the plan route line; (b) the plan route line and the flown route line are geographic representations stored as PostgreSQL-based line strings; (c) the planned route intersection object includes a plurality of FIRs traversed by the plan route line, a flight reference number, an aircraft type, a source timestamp, and origin and destination countries; and/or (d) the method further includes retrieving the selected country specific billing function from a repository of country specific billing functions stored.

21. The method of claim 16, wherein the server comprises an in-memory database and the method comprises using an in-memory queue to manage real-time flight reference queues and a parallel worker process architecture for creating separate workers to determine usage and related calculations for each flight.

22. The method of claim 21, wherein the server comprises a relational database to receive a new flight reference number for tracking a new airplane flight and to generate a trigger notification which is used to extract the flight reference number and forward it to the in-memory queue to enable immediate and real-time processing of flight information for the new airplane flight being processed, and upon determination of the new airplane being processed, a worker child process is started.

23. The method of claim 21, wherein: (i) several worker processes are used to concurrently monitor the in-memory queue for each new flight reference such that when the new flight reference is pushed to the in-memory queue, the new flight reference number is picked up by an available worker process; (ii) each worker process usage and related data for a separate airplane flight and maintain real-time synchronization with the in-memory database thereby providing concurrent processing of multiple flight references; and/or (iii) additional worker processes are generated for scaling the server to track a greater number of airplane flights.

24. The method of claim 22, wherein the relational database is used to store airspace, navigation, and billing-related data for handling of flight reference processing for a given flight reference number.

25. A device for determining airspace and airport services costs, the device comprising:
a processor configured to:
generate a plan route data by decoding a route string, wherein the plan route data includes plan route geographic coordinates generated by translating encoded waypoint data;
generate a plan route line providing a plan route geographic representation of latitude and longitude values based on the plan route geographical coordinates;
generate a flown route data by extracting sequential waypoint data from a flown navigation data, wherein the flown route data includes flown route geographic coordinates;
generate a flown route line providing a flown route geographic representation of the flown route geographic coordinates;
determine a plan route intersection object and a flown route intersection object, wherein the plan route intersection object includes a plurality of plan route intersection coordinates at the points where a plurality of FIR boundaries intersect with the plan route line, and wherein the flown route intersection object includes a plurality of flown route intersection coordinates at the points where the plurality of FIR boundaries intersect with the flown route line;
select a country billing function based on the plurality of FIR boundaries intersected by either a plan route intersection object or flown route intersection object; and
determine a charge value data by applying a selected country billing function on data values in an associated intersection object, wherein the selected country billing function is associated to either the plan route intersection object or the flown route intersection object, and wherein the data values include flight reference data, aircraft type data, FIR code, distance covered in a corresponding FIR, and time elapsed in the corresponding FIR.
